(19) United States
(12) Patent Application Publication
(10) Pub. No.: US 2020/0208280 A1
(43) Pub. Date: Jul. 2, 2020

(54) Production of Dendritic Electrocatalysts for the Reduction Of CO2 and/or CO

(71) Applicant: Siemens Aktiengesellschaft, München (DE)

(72) Inventors: Ralf Krause, Herzogenaurach (DE); Christian Reller, Minden (DE); Bernhard Schmid, Erlangen (DE); Günter Schmid, Hemhofen (DE)

(73) Assignee: Siemens Aktiengesellschaft, München (DE)

(21) Appl. No.: 16/614,989

(22) PCT Filed: Apr. 18, 2018
(86) PCT No.: PCT/EP2018/059868

§ 371 Date: Nov. 19, 2019

(30) Foreign Application Priority Data
May 19, 2017 (DE) 10 2017 208 518.5

(51) Int. Cl. C25B 11/04; B01J 37/00; B01J 37/04; B01J 37/06; B01J 6/00; C25B 9/08; B01J 23/78; B01J 23/50

(52) U.S. Cl. CPC C25B 11/04; B01J 37/0009; B01J 37/04; B01J 37/06; C25B 11/035; C25B 9/08; B01J 23/78; B01J 23/50; B01J 6/001

(57) ABSTRACT

Various embodiments include a method for producing a gas diffusion electrode comprising a metal M selected from Ag, Au, Cu and mixtures and/or alloys, the method comprising: providing a copper-, silver- and/or gold-containing starting material comprising at least one alkaline earth metal-copper, alkaline earth metal-silver and/or alkaline earth metal-gold phase, where the alkaline earth metal is selected from the group consisting of: Mg, Ca, Sr, and Ba; introducing the starting material into a solution having a pH of less than 5 and reacting to give a catalyst material; removing and washing the catalyst material; and processing the catalyst material to form a gas diffusion electrode.

### CROSS-REFERENCE TO RELATED APPLICATIONS

This application is a U.S. National Stage Application of International Application No. PCT/EP2018/059868 filed Apr. 18, 2018, which designates the United States of America, and claims priority to DE Application No. 10 2017 208 518.5 filed May 19, 2017, the contents of which are hereby incorporated by reference in their entirety.

### TECHNICAL FIELD

The present disclosure relates to electrolysis. Various embodiments may include processes for producing a gas diffusion electrode, gas diffusion electrodes, electrolysis cells, electrolysis systems, and/or methods of electrolysis of CO and/or CO₂.

### BACKGROUND

At present, about 80% of global energy demand is covered by the combustion of fossil fuels, the combustion processes of which cause global emission of about 34 000 million tonnes of carbon dioxide into the atmosphere per annum. This release into the atmosphere disposes of the majority of carbon dioxide, which can be up to 50 000 tonnes per day in the case of a brown coal power plant, for example. Carbon dioxide is one of the gases known as greenhouse gases, the adverse effects of which on the atmosphere and the climate are a matter of discussion. It is a technical challenge to produce products of value from CO₂. Since carbon dioxide is at a very low thermodynamic level, it can be reduced to useful products only with difficulty, which has left the actual reutilization of carbon dioxide in the realm of theory or in the academic field to date.

Natural carbon dioxide degradation proceeds, for example, via photosynthesis. This involves conversion of carbon dioxide to carbohydrates in a process subdivided into many component steps over time and, at the molecular level, in terms of space. As such, this process cannot easily be adapted to the industrial scale. No copy of the natural photosynthesis process with photocatalysis on the industrial scale to date has had adequate efficiency.

An alternative is the electrochemical reduction of carbon dioxide. Systematic studies of the electrochemical reduction of carbon dioxide are still a relatively new field of development. Only in the last few years have there been efforts to develop an electrochemical system that can reduce an acceptable amount of carbon dioxide. Research on the laboratory scale has shown that electrolysis of carbon dioxide is preferably accomplished using metals as catalysts. The publication “Electrochemical CO₂ reduction on metal electrodes” by Y. Hori, published in: C. Vayenas, et al. (eds.), Modern Aspects of Electrochemistry, Springer, New York, 2008, p. 89-189, discloses, by way of example, Faraday efficiencies at different metal cathodes, some of which are listed by way of example in table 1.

TABLE 1
Faraday efficiencies for the conversion of CO2
to various products at various metal electrodes

| Electrode | CH₄ | C₂H₄ | C₂H₅OH | C₃H₇OH | CO | HCOO⁻ | H₂ | Total |
|---|---|---|---|---|---|---|---|---|
| Cu | 33.3 | 25.5 | 5.7 | 3.0 | 1.3 | 9.4 | 20.5 | 103.5 |
| Au | 0.0 | 0.0 | 0.0 | 0.0 | 87.1 | 0.7 | 10.2 | 98.0 |
| Ag | 0.0 | 0.0 | 0.0 | 0.0 | 81.5 | 0.8 | 12.4 | 94.6 |
| Zn | 0.0 | 0.0 | 0.0 | 0.0 | 79.4 | 6.1 | 9.9 | 95.4 |
| Pd | 2.9 | 0.0 | 0.0 | 0.0 | 28.3 | 2.8 | 26.2 | 60.2 |
| Ga | 0.0 | 0.0 | 0.0 | 0.0 | 23.2 | 0.0 | 79.0 | 102.0 |
| Pb | 0.0 | 0.0 | 0.0 | 0.0 | 0.0 | 97.4 | 5.0 | 102.4 |
| Hg | 0.0 | 0.0 | 0.0 | 0.0 | 0.0 | 99.5 | 0.0 | 99.5 |
| In | 0.0 | 0.0 | 0.0 | 0.0 | 2.1 | 94.9 | 3.3 | 100.3 |
| Sn | 0.0 | 0.0 | 0.0 | 0.0 | 7.1 | 88.4 | 4.6 | 100.1 |
| Cd | 1.3 | 0.0 | 0.0 | 0.0 | 13.9 | 78.4 | 9.4 | 103.0 |
| Tl | 0.0 | 0.0 | 0.0 | 0.0 | 0.0 | 95.1 | 6.2 | 101.3 |
| Ni | 1.8 | 0.1 | 0.0 | 0.0 | 0.0 | 1.4 | 88.9 | 92.4 |
| Fe | 0.0 | 0.0 | 0.0 | 0.0 | 0.0 | 0.0 | 94.8 | 94.8 |
| Pt | 0.0 | 0.0 | 0.0 | 0.0 | 0.0 | 0.1 | 95.7 | 95.8 |
| Ti | 0.0 | 0.0 | 0.0 | 0.0 | 0.0 | 0.0 | 99.7 | 99.7 |

Table 1 reports Faraday efficiencies FE (in [%]) of products that form in the reduction of carbon dioxide at various metal electrodes. The values reported are applicable here to a 0.1 M potassium hydrogencarbonate solution as electrolyte.

While carbon dioxide is reduced almost exclusively to carbon monoxide at silver, gold, zinc, palladium and gallium cathodes, for example, a multitude of hydrocarbons form as reaction products at a copper cathode. For example, at a silver cathode, predominantly carbon monoxide and a little hydrogen would form. Possible reactions at anode and cathode can be represented by the following reaction equations:

2CO₂+4e⁻+4H⁺→2CO+2H₂O Cathode:

2H₂O→O₂+4H⁺+4e⁻ Anode:

Of particular economic interest, for example, is the electrochemical production of carbon monoxide, ethylene or alcohols. Further examples of possible products are shown below:

CO₂+2e⁻+H₂O→CO+2OH⁻ Carbon monoxide:

2CO₂+12e⁻+8H₂O→C₂H₄+12OH⁻ Ethylene:

CO₂+8e⁻+6H₂O→CH₄+8OH⁻ Methane:

2CO₂+12e⁻+9H₂O→C₂H₅OH+12OH⁻ Ethanol:

2CO₂+10e⁻+8H₂O→HOC₂H₄OH+10OH⁻ Monoethylene glycol:

The reaction equations show that, for the production of ethylene from CO₂, for example, 12 electrons have to be transferred. The stepwise reaction of CO₂ proceeds via a multitude of surface intermediates (—CO₂⁻, —CO, ═CH₂, —H). For each of these intermediates, there should be a strong interaction with the catalyst surface or the active sites, such that a surface reaction (or further reaction) between the corresponding adsorbates is enabled. Product selectivity is thus directly dependent on the crystal area or interaction thereof with the surface species.

For example, an elevated ethylene selectivity has been shown by experiments on monocrystalline high-index surfaces (Cu 711, 511) [see Journal of Molecular Catalysis A Chemical 199(1):39-47, 2003]. Materials that have a high number of crystallographic levels or have surface defects likewise have elevated ethylene selectivities, as shown in C. Reller, R. Krause, E. Volkova, B. Schmid, S. Neubauer, A. Rucki, M. Schuster, G. Schmid, Adv. Energy Mater. 2017, 1602114, and DE102015203245 A1. There is thus a close relationship between the nanostructure of the catalyst material and the ethylene selectivity.

For the selective production of the carbon monoxide product, there are already pure silver catalysts available that meet industrial demands. For the selective electroreduction of CO₂ to ethylene or alcohols, however, there are no known catalysts as yet that meet these demands.

As well as the property of selectively forming ethylene, the material, even at high conversion rates (current densities), should retain its product selectivity, i.e. the advantageous structure of the catalyst centers should be conserved. Owing to the high surface mobility of copper, however, the defects or nanostructures generated typically do not have prolonged stability, and so, even after a short time of 60 min, degradation of the electrocatalyst is observed. As a result of the structural alteration, the material loses the propensity to form ethylene. Moreover, with voltage applied to structured surfaces, the potentials vary easily, such that certain intermediates are formed preferentially in a small area at certain points, and these can then react further at a slightly different point. As studies by the inventors here have shown, potential variations well below 50 mV are significant.

There is no available catalyst system having prolonged stability that can electrochemically reduce CO2 to ethylene at high current density >100 mA/cm². Current densities of industrial relevance can typically be achieved using gas diffusion electrodes. This is known from the existing prior art, for example, for chloralkali electrolyses implemented on the industrial scale. Known Cu-based gas diffusion electrodes for production of hydrocarbons based on CO2 can be found, for example, in the studies by R. Cook, J. Electrochem. Soc., vol. 137, no. 2, 1990, in which a wet-chemical method based on a PTFE 30B (suspension)/Cu(OAc)2/Vulkan XC 72 mixture is mentioned. The method states how, using three coating cycles, a hydrophobic conductive gas transport layer and, using three further coatings, a catalyst-containing layer are applied. Each layer is followed by a drying phase (325° C.) with a subsequent static pressing operation (1000-5000 psi). For the electrode obtained, a Faraday efficiency of >60% and a current density of >400 mA/cm² were reported. Reproduction experiments demonstrate that the static pressing method described does not lead to stable electrodes. An adverse effect of the Vulkan XC 72 included in the mixture was likewise found, and so likewise no hydrocarbons were obtained.

In order to increase the number of structure defects, one option is nanostructuring of the catalyst material. It has been observed that isolated copper nanoclusters present, for example, in oxide-supported copper catalysts can lead to increased formation of the CO intermediate, but to a lesser degree, if at all, enable the desired further reaction to give ethylene. If, by contrast, dendritic or coherent nanostructures are produced, the intermediates at the surface can be stabilized and react further to give ethylene. The copper nanodendrites produced may likewise be oxide-stabilized.

The production of such copper dendrites is not achievable by that synthesis route by the synthesis methods known since the crystal growth in the process for reduction of the precursor oxide proceeds too slowly during the activation with hydrogen, and so usually isolated copper clusters or solid particles are obtained. Chemical reduction methods with N₂H₄ or NaBH₄ likewise lead to spherical primary particles that agglomerate later on in the reaction. The catalysts obtained in turn lead, in the electrolysis, to increased formation of CO.

Anisotropic crystal growth is generally obtained by these methods using capping agents, for example ethylenediamine. However, the Cu nanowires produced have barely any structural defects since the crystal growth takes place comparatively slowly.

### SUMMARY

The present disclosure describes production processes for gas diffusion electrodes having prolonged stability with good Faraday efficiency for desired products and corresponding gas diffusion electrodes. The electrocatalyst used in the gas diffusion electrode should ideally enable a high Faraday efficiency at high current density for a corresponding target product.

Electrocatalysts of industrial relevance should additionally likewise have prolonged stability.

As an example, some embodiments include a process for producing a gas diffusion electrode comprising a metal M selected from Ag, Au, Cu and mixtures and/or alloys, comprising: providing a copper-, silver- and/or gold-containing starting material comprising at least one alkaline earth metal-copper, alkaline earth metal-silver and/or alkaline earth metal-gold phase, where the alkaline earth metal is selected from Mg, Ca, Sr, Ba and mixtures thereof; introducing the starting material into a solution having a pH of less than 5 and reacting to give a catalyst material; removing, washing and optionally drying the catalyst material; and processing the catalyst material to give a gas diffusion electrode.

In some embodiments, the starting material comprises the alkaline earth metal in an amount of 1 to 99 at. %, 55 to 98 at. %, 60 to 95 at. %, or even 62 to 90 at. %, wherein the starting material has at least one phase selected from: Mg₂Cu, CaCu₅, SrCu₅, CuSr, BaCu, BaCu₁₃, Ca₂Ag₉, Ca₂Ag₇, CaAg₂, Ca₅Ag₃, MgAg, Mg₂₅Ag₈, SrAg₅, SrAg₂, SrAg, Sr₃Ag₂, BaAg₅, BaAg₂, BaAg, CaAu₅, CaAu₃, CaAu₂, CaAu, Ca₅Au₄, Ca₇Au₃, MgAu, Mg₂Au, Mg₃Au, SrAu₅, SrAu₂, SrAu, Sr₃Au₂, Sr₇Au₃, Sr₉Au, BaAu₅, BaAu₂, Ba₃Au₂, BaAu and mixtures thereof.

In some embodiments, the catalyst material, after the removal, washing and optionally drying of the catalyst material, is calcined, wherein the starting material, on introduction of the starting material into a solution having a pH of less than 5 and reacting to give a catalyst material, is not completely reacted.

In some embodiments, on introduction of the starting material, at least one compound of Cu, Ag and/or Au, preferably of Cu⁺, Ag⁺ and/or Au⁺, is also introduced, and/or wherein, on introduction of the starting material, at least one carrier material selected from metal oxides, Al₂O₃, MgO, TiO₂, Y₂O₃, ZrO₂ and mixtures thereof, is also introduced, wherein the proportion of the carrier material in the catalyst material is 2% to 40% by weight, 3% to 30% by weight, or 5% to 10% by weight.

In some embodiments, the processing of the catalyst material to give a gas diffusion electrode comprises the following steps: producing a mixture comprising the catalyst material and at least one binder, applying the mixture comprising the catalyst material and at least one binder to a substrate, preferably in the form of a sheetlike structure, and dry or moistened rolling of the mixture onto the carrier to form a layer; or applying the catalyst material to a substrate, preferably in the form of a sheetlike structure, and dry or moistened rolling of the catalyst material onto the carrier to form a layer.

As another example, some embodiments include a gas diffusion electrode comprising a metal M selected from Ag, Au, Cu and mixtures and/or alloys, wherein the gas diffusion electrode comprises dendritic and amorphous structures, wherein the gas diffusion electrode comprises dendrites containing alkaline earth metal-copper, alkaline earth metal-silver and/or alkaline earth metal-gold phases and/or at least one alkaline earth metal oxide.

In some embodiments, the gas diffusion electrode further comprises Cu, Ag and/or Au in the +I valency, e.g. as a compound with O, S, Se, As, Sb, etc., in the form of an oxide.

In some embodiments, there is at least one carrier material selected from metal oxides, e.g. Al₂O₃, MgO, TiO₂, Y₂O₃, ZrO₂ and mixtures thereof.

In some embodiments, there is at least one binder and optionally a substrate.

As another example, some embodiments include a gas diffusion electrode produced by the process as described above.

As another example, some embodiments include an electrolysis cell comprising a gas diffusion electrode as described above as cathode, an anode and optionally at least one membrane and/or at least one diaphragm between the cathode and anode.

As another example, some embodiments include an electrolysis system comprising a gas diffusion electrode as described above or an electrolysis cell as described above.

As another example, some embodiments include a method of electrolysis of CO₂ and/or CO, wherein a gas diffusion electrode as described above is used as cathode, or wherein an electrolysis cell as described above or an electrolysis system as described above is used.

### BRIEF DESCRIPTION OF THE DRAWINGS

The appended drawings are intended to illustrate embodiments of the teachings of the present disclosure and impart further understanding thereof. In association with the description, they serve to elucidate concepts and principles described herein. Other embodiments and many of the advantages mentioned are apparent with regard to the drawings. The elements of the drawings are not necessarily shown true to scale with respect to one another. Elements, features and components that are the same, have the same function and the same effect are each given the same reference numerals in the figures of the drawings, unless stated otherwise.

FIGS. 1 to 6 show phase diagrams for systems of Cu, Ag, and Au with illustrative alkaline earth metals.

FIG. 7 shows a schematic diagram of a particular embodiment of a gas diffusion incorporating teachings of the present disclosure.

FIG. 8 shows an illustrative diagram of a possible construction of an electrolysis cell incorporating teachings of the present disclosure.

FIG. 9 shows a second illustrative diagram of a possible construction of an electrolysis cell incorporating teachings of the present disclosure.

FIG. 10 shows a third illustrative diagram of a possible construction of an electrolysis cell incorporating teachings of the present disclosure.

FIG. 11 shows a further illustrative diagram of a possible construction of an electrolysis cell incorporating teachings of the present disclosure.

FIG. 12 shows a configuration of an illustrative electrolysis system for CO₂ reduction.

FIGS. 13 and 14 show further illustrative configurations of an electrolysis system for CO₂ reduction incorporating teachings of the present disclosure.

FIGS. 15 to 42 show data of results in the examples and comparative examples incorporating teachings of the present disclosure.

### DETAILED DESCRIPTION

The inventors have found that gas diffusion electrodes having prolonged stability for use in the electrolysis of CO₂ and/or CO comprising dendritic structures for production of desired products can be obtained when the starting material used in the production is one comprising at least one alkaline earth metal-copper, alkaline earth metal-silver and/or alkaline earth metal-gold phase. The synthesis concept described here especially enables the production of electrocatalysts with a low overvoltage and an elevated selectivity for ethylene and alcohols. Processes incorporating the teachings herein enable production of very pure catalysts that do not have any disadvantageous impurities of other transition metals. It is not ruled out here that residues of the alloy constituents of the alkaline earth metals may also remain in the catalyst or an electrode formed, and these may also react to give carbonates such as alkaline earth metal carbonates and be formed on the surface.

Some embodiments include a process for producing a gas diffusion electrode comprising a metal M selected from Ag, Au, Cu and mixtures and/or alloys thereof, comprising:
providing a copper-, silver- and/or gold-containing starting material comprising at least one alkaline earth metal-copper, alkaline earth metal-silver and/or alkaline earth metal-gold phase, where the alkaline earth metal is selected from Mg, Ca, Sr, Ba and mixtures thereof;
introducing the starting material into a solution having a pH of less than 5 and reacting to give a catalyst material;
removing, washing and optionally drying the catalyst material; and
processing the catalyst material to give a gas diffusion electrode.

Some embodiments include a gas diffusion electrode comprising a metal M selected from Ag, Au, Cu and mixtures and/or alloys thereof, wherein the gas diffusion electrode comprises dendritic and amorphous structures.

Some embodiments include a gas diffusion electrode produced by the processes described herein.

Some embodiments include an electrolysis cell comprising a gas diffusion electrode as described herein, e.g. as cathode, an anode and optionally at least one membrane and/or at least one diaphragm between the cathode and anode.

Some embodiments include an electrolysis system comprising a gas diffusion electrode or an electrolysis cell described herein.

Some embodiments include a method of electrolysis of CO₂ and/or CO, wherein a gas diffusion electrode as described herein is used as cathode, or wherein an electrolysis cell or an electrolysis system as described herein is used.

Some embodiments include a catalyst material comprising a metal M selected from Ag, Au, Cu and mixtures and/or alloys and/or salts thereof, wherein the catalyst material comprises dendritic and amorphous structures.

### Definitions

Unless defined differently, technical and scientific expressions used herein have the same meaning as commonly understood by a person skilled in the art in the technical field of the present disclosure.

Gas diffusion electrodes (GDEs) are electrodes in which liquid, solid and gaseous phases are present, and where, in particular, a conductive catalyst catalyzes an electrochemical reaction between the liquid phase and the gaseous phase.

In the present disclosure, “hydrophobic” means water-repellent. Hydrophobic pores and/or channels are thus those that repel water. In particular examples, hydrophobic properties are associated in accordance with substances or molecules having nonpolar groups.

By contrast, “hydrophilic” means the ability to interact with water and other polar substances.

In the present disclosure, figures are given in % by weight, unless stated otherwise or apparent from the context. In the gas diffusion electrode of the invention, the percentages by weight add up to 100% by weight.

Standard pressure is 101 325 Pa=1.01325 bar.

Some embodiments include a process for producing a gas diffusion electrode comprising a metal M selected from Ag, Au, Cu and mixtures and/or alloys thereof, comprising:
providing a copper-, silver- and/or gold-containing starting material comprising at least one alkaline earth metal-copper, alkaline earth metal-silver and/or alkaline earth metal-gold phase, where the alkaline earth metal is selected from Mg, Ca, Sr, Ba and mixtures thereof;
introducing the starting material into a solution having a pH of less than 5 and reacting to give a catalyst material;
removing, washing and optionally drying the catalyst material; and
processing the catalyst material to give a gas diffusion electrode.

In some embodiments, Cu, Ag, and/or Au, may serve as conductive metal and also as catalyst, and they are therefore present on provision of a copper-, silver-, and/or gold-containing starting material comprising at least one alkaline earth metal-copper, alkaline earth metal-silver and/or alkaline earth metal-gold phase, where the alkaline earth metal is selected from Mg, Ca, Sr, Ba and mixtures thereof. One example alkaline earth metal here for production of the gas diffusion electrode is Mg, but it is also possible to obtain gas diffusion electrodes having prolonged stability with Ca, Sr and/or Ba. In some embodiments, mixtures of the alkaline earth metals may be present in the starting material. In particular embodiments, however, the starting material comprises just one alkaline earth metal.

There are also possible starting materials in which mixtures of copper, silver, and/or gold are present, but, in particular embodiments, starting materials in which just one of copper, silver and/or gold is present are used. The provision of the starting material is not particularly restricted, and the starting material may be provided, for example, in the form of particles, powders, etc.

An alloy comprising the alkaline earth metals, for example Cu—Mg, has the advantage over other alloys, for example with Al, Zr, Zn, e.g. Cu—Al, Cu—Zr, CuZn, that there exist no acid-stable intermetallic phases (e.g. Al₂Cu) that can cause unwanted hydrogen formation in the electroreduction of CO₂. Accordingly, on introduction of the starting material into a solution having a pH of less than 5 and reacting to give a catalyst material, dendrites can be produced as a result of the leaching of the alkaline earth metal. By virtue of the alkaline earth metal, e.g. magnesium, as template, it is possible to produce this material. Morphologies obtainable by the processes herein include not only the thermodynamic minimum surfaces (111, 100).

The amount of alkaline earth metal in the starting material is not particularly restricted. In particular embodiments, the starting material comprises the alkaline earth metal in an amount of 1 to 99 at. %, e.g. 12 to 98.5 at. %, 55 to 98 at. %, 60 to 95 at. %, or even 62 to 90 at. %, e.g. 65 to 90 at. %, e.g. 65 to 80 at. %, where, in particular embodiments, the rest of the starting material is formed essentially by the metal M. For the reaction, it is thus possible to select element compositions over the entire range of the phase diagram, e.g. 1 at. % Mg-99 at. % Mg, or a range of 90 at. % Mg-65 at. % Mg. The alloy used may have a content of metal M, for example copper content, of 35 at. %, and an alkaline earth metal content of 65 at. %, e.g. Mg.

In particular embodiments, the starting material has at least one phase selected from Mg₂Cu, CaCu₅, SrCu₅, CuSr, BaCu, BaCu₁₃, Ca₂Ag₉, Ca₂Ag₇, CaAg₂, Ca₅Ag₃, MgAg, Mg₂₅Ag₈, SrAg₅, SrAg₂, SrAg, Sr₃Ag₂, BaAg₅, BaAg₂, BaAg, CaAu₅, CaAu₃, CaAu₂, CaAu, Ca₅Au₄, Ca₇Au₃, MgAu, Mg₂Au, Mg₃Au, SrAu₅, SrAu₂, SrAu, Sr₃Au₂, Sr₇Au₃, Sr₉Au, BaAu₅, BaAu₂, Ba₃Au₂, BaAu and mixtures thereof, e.g. Mg₂Cu, Mg₂₅Ag₈ and/or Mg₂Au, where M is selected from Ag, Au, Cu and mixtures and/or alloys thereof. With these phases, it is possible to form dendritic structures in the gas diffusion electrode. In particular embodiments, the starting material consists essentially of a phase selected from Mg₂Cu, CaCu₅, SrCu₅, CuSr, BaCu, BaCu₁₃, Ca₂Ag₉, Ca₂Ag₇, CaAg₂, Ca₅Ag₃, MgAg, Mg₂₅Ag₈, SrAg₅, SrAg₂, SrAg, Sr₃Ag₂, BaAg₅, BaAg₂, BaAg, CaAu₅, CaAu₃, CaAu₂, CaAu, Ca₅Au₄, Ca₇Au₃, MgAu, Mg₂Au, Mg₃Au, SrAu₅, SrAu₂, SrAu, Sr₃Au₂, Sr₇Au₃, Sr₉Au, BaAu₅, BaAu₂, Ba₃Au₂, BaAu and mixtures thereof, where M is selected from Ag, Au, Cu and mixtures and/or alloys thereof, where other phases may also be present in the starting material.

In some embodiments, the starting alloy consists, for example, mainly of the intermetallic Laves phase Mg₂Cu. However, there may likewise be traces here of the Laves phase Cu₂Mg. As well as the stable intermetallic phases Cu₂Mg and Mg₂Cu, a third metastable Cu₃Mg phase is known, which can be obtained by rapid quenching of a melt. By rapid solidification, it is likewise possible to obtain an amorphous alloy having a magnesium content of 14.5 at. %, in which the short-range order of the copper atoms corresponds to that of the Mg₂Cu phase and which can likewise be used for the synthesis of the copper dendrites.

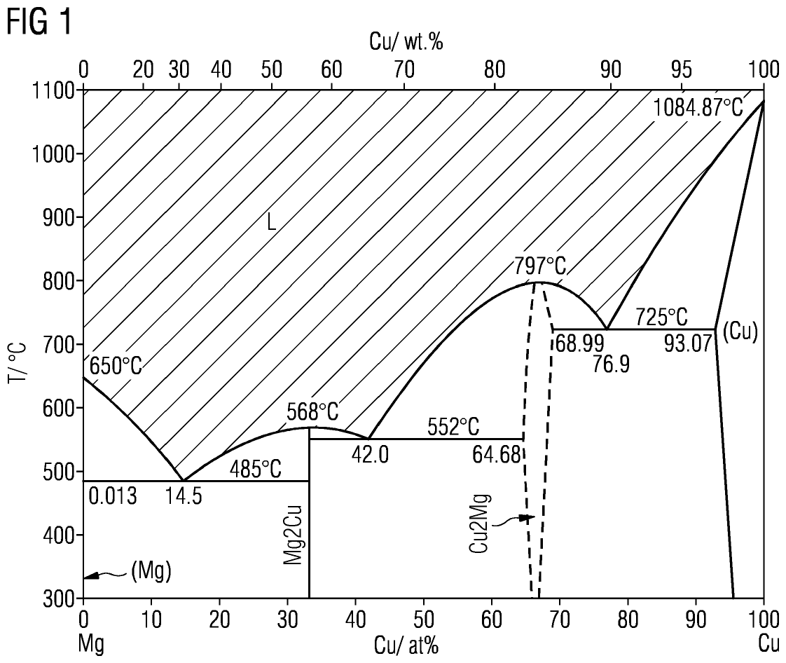

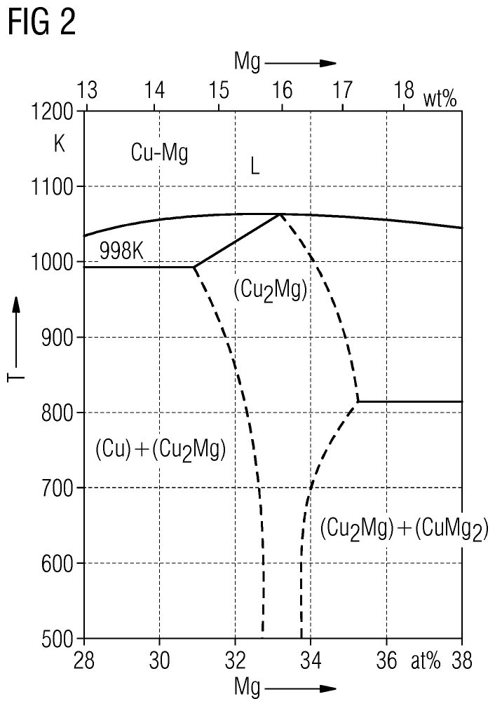

Suitable phases can be determined, for example, in a simple manner with the aid of phase diagrams. For example, FIG. 1 shows a phase diagram for the Cu—Mg system, and FIG. 2 the homogeneity range of Cu₂Mg in the detail range of 28-38 at. % Mg [both taken from (B. Predel: Phase Equilibria, Crystallographic, Thermodynamic Data of Binary Alloys, Landolt Börnstein, NEW Series IV/5 Springer Berlin, Heidelberg 1991-1998)].

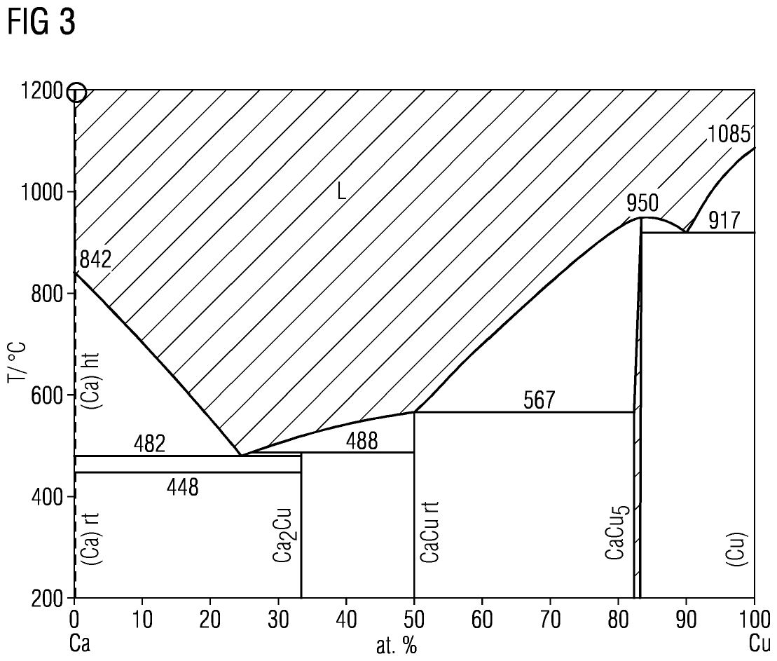

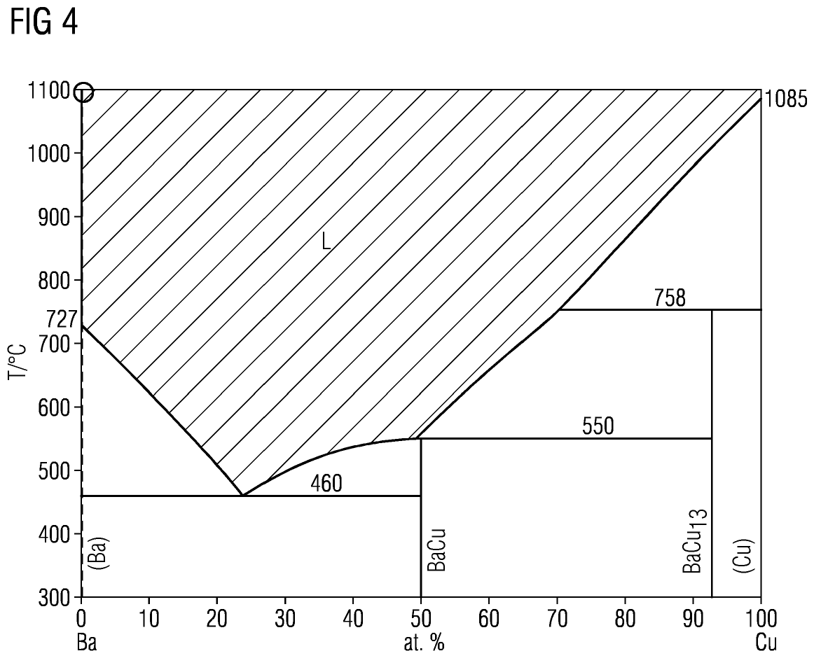

For example, as well as the Cu—Mg system, Cu—Ca and Cu—Ba alloys are also conceivable as starting material, but these are more difficult to prepare and process. The corresponding phase diagrams are shown by way of example in FIG. 3 and FIG. 4, FIG. 3 showing the phase diagram for Cu—Ca (http://materials.springer.com/isp/phase-diagram/docs/c_0900536), and FIG. 4 the phase diagram for Cu—Ba (Okamoto, Hiroaki, Ba—Cu Binary Phase Diagram 0-100 at. % Cu, Springer Materials, Berlin Heidelberg 2012).

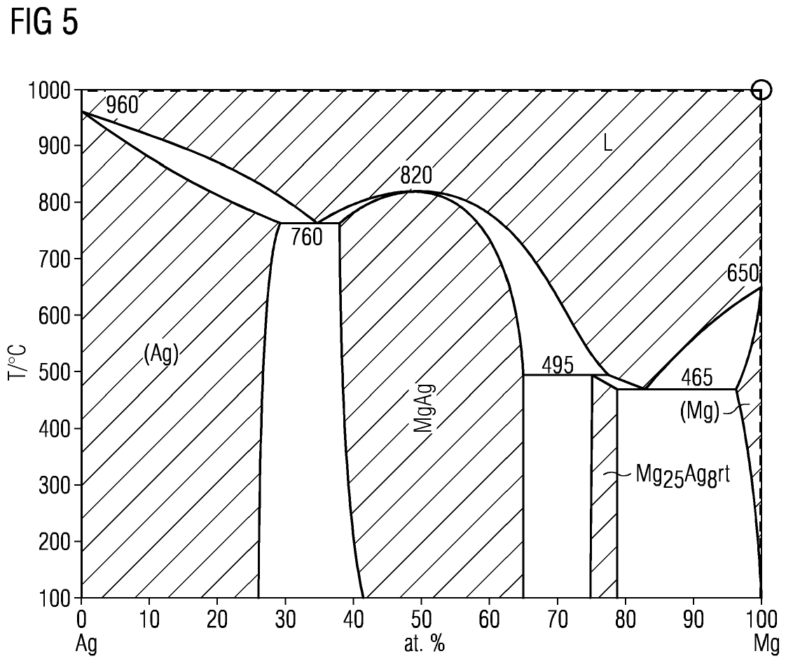

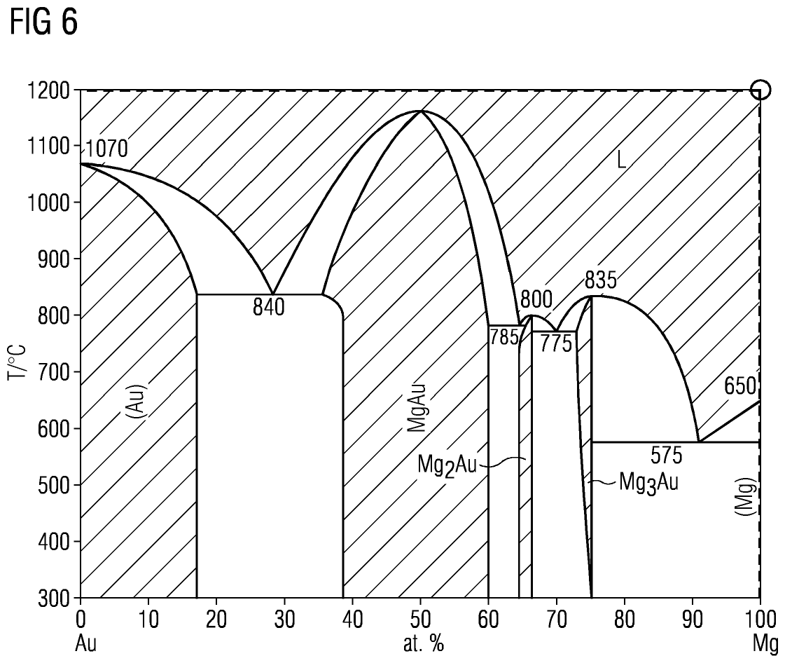

As well as Cu, suitable phases as starting material are also known for Ag and Au, and phase diagrams are shown here by way of example for the Ag—Mg system in FIG. 5 and for the Au—Mg system in FIG. 6 (G. Zanicchi, R. Marazza, O. Fabrichnaya and MSIT®, G. MSI Eureka in Springer Materials, 2002; Inorganic Solid Phases, Springer Materials, Springer, Heidelberg (ed.), 2016.)

In some embodiments, the starting material is provided in powder form with a particle size of less than 500 μm, less than 350 μm, e.g. 200 μm or less, for example 100 μm or less, <75 μm, and/or >200 nm, e.g. >500 nm, and in some cases even 10 μm or more. In particular embodiments, it is possible to use particles having a coarser grain size of 75 μm-200 μm, for example in a proportion of 50-95% by weight, e.g. 85-95% by weight, based on the starting material. The particle size can be determined here, for example, by microscopy by means of image analysis, by laser diffraction and/or by dynamic light scattering. In addition, the particles of the starting material/alloy, in particular embodiments, have a high purity without extraneous metal traces.

The introduction of the starting material into a solution having a pH of less than 5 and reacting to give a catalyst material is not restricted. This can result in the reacting of the alkaline earth metal and the forming of the catalyst structure for the gas diffusion electrode. The solution having a pH of less than 5, less than 4, less than 3, or even less than 2, for example less than 1, i.e. highly acidic, is not particularly restricted, and it may be a solution of an acid in a suitable solvent, e.g. water. The acid here is not particularly restricted; for example, the anion of the acid with the alkaline earth metal forms a soluble compound in the solvent, i.e., for example, a water-soluble salt, such that the remaining material can easily be removed. A suitable acid is, for example, aqueous hydrochloric acid, acetic acid, etc.

During the acid treatment of the alloy, there is rapid leaching of the alkaline earth metal, for example of magnesium atoms, out of the metal lattice of the metal M, at first giving rise to a Raney-like structure, e.g. Raney copper structure.

An illustrative dissolution process for a Cu—Mg system is as follows:

Cu₂Mg+2HCl→2Cu+MgCl₂+H₂

CuMg₂+4HCl→Cu+2MgCl₂+2H₂

Mg+2HCl→MgCl₂+H₂

The subsequent removal, washing and optionally drying of the catalyst material is not particularly restricted. For example, it may be filtered off and washed with water, e.g. bidistilled water, although any other removal and also washing with other solvents is possible.

In some embodiments, the catalyst material, after the removal, washing and optionally drying of the catalyst material, is calcined or partly oxidized. In particular embodiments, the starting material, on introduction of the starting material into a solution having a pH of less than 5 and reacting to give a catalyst material, is not completely reacted, especially when the catalyst material is calcined after the removal, washing and optionally drying of the catalyst material. This may suitably be established, for example, via the reaction time, depending on the metal M and the alkaline earth metal and the acid used, etc. For example, the termination time at a pH of 1 or less may be 10 s, and a weaker acid may be used to optimize the termination time. For instance, when the acid strength is halved, the termination time can usually be extended by about a factor of 2.

The calcining here is not particularly restricted and can be effected, for example, under air or in an O₂/argon gas stream and/or in the presence of S, Se, H₂S, H₂Se, PH₃, etc., for example for a doping operation. A thermal treatment is also possible here.

The oxide precursors produced may, according to the method, be reduced directly thereafter in an H₂/Ar gas stream. The activation step can also be effected subsequently by electrochemical means. In order to improve the electrical conductivity of the layer applied prior to the electrochemical activation, it is also possible to some degree to mix oxide precursors and activated precursors. It is likewise not ruled out that the ready-calendered electrode may be subjected to a subsequent calcination/thermal treatment before the electrochemical activation is conducted.

In some embodiments, on introduction of the starting material, at least one compound of Cu, Ag and/or Au, preferably of Cu⁺, Ag⁺ and/or Au⁺, is also introduced. This compound is not particularly restricted here and may include, for example, salts and/or complexes of the metals. Illustrative compounds are also described hereinafter in conjunction with the gas diffusion electrode of the invention. It is also possible for such a compound to be introduced after the removal, washing and optional drying and optional calcination, before the catalyst material is processed to give a gas diffusion electrode.

If the acid treatment takes place in the presence of dissolved metal ions, e.g. copper ions, in addition to the production of a defect-rich Raney structure, dendritic copper structures can be grown on simultaneously. In this process, hydrogen bubbles that have formed, for example from the acid, can serve as template for the copper growth. A corresponding effect has already been demonstrated in the electrochemical deposition of copper at high potentials. For this approach, an alkaline earth metal-rich, e.g. magnesium-rich, phase, e.g. Mg₂Cu, may be used. For instance, Mg₂Cu has much greater hydrolysis characteristics than Cu₂Mg since the bond strength of the Cu—Cu bond is much lower. Hydrolysis characteristics can be observed here, for example, even in pure water [Materials Letters 2008, 62, 19, p. 3331-3333].

In some embodiments, a metal oxide of the metal M is formed in the +I oxidation state of the metal. Preparation in the presence of atmospheric oxygen, for example, is sufficient for this purpose. Performance of the synthesis under inert gas is thus not advantageous. The presence of the metal M in the +I state in the form of an oxide can stabilize the catalyst structure. As well as structural aspects, a thin layer of Cu₂O in particular on the surface of the catalyst material promotes the ethylene selectivity of the catalyst.

In some embodiments, on introduction of the starting material, at least one carrier material selected from metal oxides, e.g. Al₂O₃, e.g. γ-Al₂O₃, MgO, TiO₂, Y₂O₃, ZrO₂ and mixtures thereof is also introduced, wherein the proportion of the carrier material in the catalyst material may be 2% to 40% by weight, 3% to 30% by weight, or even 5% to 10% by weight. This too can be introduced on introduction of the starting material and/or after the removal, washing and optional drying and optional calcination.

The carrier material here can form mixed oxides with the alkaline earth metal, which can further stabilize the gas diffusion electrode and/or the catalyst material. For example, when Mg is present in the material, in the case of addition of TiO₂, oxides such as Mg₂TiO₄ are integrated and not just mixed into the metal M, e.g. copper. These can additionally stabilize the +I oxidation state of the metal M, e.g. Cut, which is important for catalysis.

However, a disadvantage in the case of Cu as metal M has been found here to be preparation in the presence of a dissolved salt of the metal M, i.e. of a copper salt, since the impregnation results in formation of supported Cu clusters that can have a Faraday efficiency of >45% for CO. The supported catalysts, i.e. with the carrier material, preferably have an oxide content of 3% to 35% by weight, e.g. 4-30% by weight. This oxide content may be in the range of 5-10% by weight, for example about 10% by weight. It has been observed that it is also possible for the synthesis to form a small proportion (<2%) of an inverse spinel, for example of an Mg₂TiO₄ spinel.

Some embodiments include in situ stabilization of the structure, for example for Cu the attainment of the copper percolation barrier, such that the material is electrically conductive. In some embodiments, some of the metal M that occurs in the catalyst, e.g. copper, may be in the form of metal(I) oxide, e.g. copper(I) oxide. The occurrence of metal(II) oxide, e.g. copper(II) oxide, may be avoided, such that it accounts for a proportion of not more than 5% by weight, less than 2% by weight, or less than 1% by weight, based on the catalyst material, and/or essentially does not occur in the catalyst material. Supporting on oxide can result in an elevated stability of the catalyst (for example with 10% by weight of TiO₂) at current densities of >250 mA/cm².

The processing of the catalyst material to give a gas diffusion electrode is not particularly restricted. In particular embodiments, the processing of the catalyst material to give a gas diffusion electrode comprises the following steps:
producing a mixture comprising the catalyst material and at least one binder,
applying the mixture comprising the catalyst material and at least one binder to a substrate, preferably in the form of a sheetlike structure, and
dry or moistened rolling of the mixture onto the carrier to form a layer; or
applying the catalyst material to a substrate, preferably in the form of a sheetlike structure, and
dry or moistened rolling of the catalyst material onto the carrier to form a layer. In addition, it is possible to use a non-solvent-casting method as a roll-to-roll process, etc., which is known from the prior art.

If an application of the catalyst material to a substrate, e.g. in the form of a sheetlike structure, and dry or moistened rolling of the catalyst material onto the carrier to form a layer is effected, it is then possible to also form thereon a further layer with a binder and the catalyst material. On the other hand, in the case of the production of a mixture comprising the catalyst material and at least one binder, the applying of the mixture comprising the catalyst material and at least one binder to a substrate, e.g. in the form of a sheetlike structure, and the dry or moistened rolling of the mixture onto the carrier to form a layer, it is also possible to apply a further layer comprising the catalyst material and optionally a binder, possibly in a smaller amount than in the layer applied first, to said layer. It is thus also possible to form multilayer gas diffusion electrodes. The multilayers may also be formed simultaneously on the substrate by applying the corresponding materials consecutively to the substrate.

In some embodiments, in the production process, a dry calendering method is used, in which, for example, a mixture of binder, for example a cold-flowing polymer, e.g. preferably PTFE, the respective powder of the metal M or the catalyst powder and optionally the powder of a carrier material is prepared, for example in an intensive mixing apparatus or on laboratory scale with a knife mill (IKA). The mixture can be produced using a knife mill, for example, where the mixing time may, for example, be 60-200 s, preferably 90-150 s. The mixing procedure may also, for example, follow the following procedure: grinding/mixing for 30 sec and wait for 15 sec for a total of 6 min, based on the knife mill with total loading 50 g. A base layer may be produced, for example, from powder mixtures of a metal M, e.g. a Cu powder, with a grain size of 100-160 μm with binder, e.g. 10-15% by weight of Dyneon TF 1750 PTFE, or 7-10% by weight of Dyneon TF 2021.

In some embodiments, the binder comprises a polymer, for example a hydrophilic and/or hydrophobic polymer, for example a hydrophobic polymer, e.g. PTFE. This can achieve suitable adjustment of the predominantly hydrophobic pores or channels. After the mixing operation, the mixed powder may obtain a slightly tacky consistency. According to the amount of powder or polymer chosen or chain length or ion exchange material, the mixing time before this state is attained may also vary.

In some embodiments, the catalyst material for the production of the mixture is in the form of particles or catalyst particles that have a uniform size, for example, between 1 and 80 μm, 2 to 50 μm, or between 3-5 μm. The particle size can be determined here, for example, by microscopy by means of image analysis, by laser diffraction and/or by dynamic light scattering. In addition, the catalyst particles and/or alloy particles, in particular embodiments, have a high purity without extraneous metal traces. By means of suitable structuring, optionally with the aid of the promoters as described above, it is possible to achieve a high selectivity and long-term stability.

In some embodiments, it is also possible to introduce an ion exchange material into one or more layers of the GDE or, together with the material, to a commercially available GDE. For example, it is possible to use an ionomer, for example 20% alcoholic suspension or a 5% suspension of an anion exchange ionomer (As 4 Tokuyama). In addition, it is possible, for example, to use type 1 and type 2 anion exchange resins.

By suitable adjustment of the particle sizes of metal M, binder and any further materials, e.g. carrier material, ion exchange material, etc., it is possible to specifically control the pores and/or channels, i.e. the hydrophobic and hydrophilic pores and/or channels, of the GDE for the passage of gas and/or electrolyte and hence for the catalytic reaction. The applying of a first and further mixture(s) is not particularly restricted and can be effected, for example, by scattering, sieving, squeegeeing, etc.

The resultant powder mixture may thus, for example, subsequently be scattered or sieved in a suitable layer thickness onto the carrier, for example a metal mesh, for example with a mesh size of >0.5 mm<1.0 mm and a wire diameter of 0.1-0.25 mm. In order that the powder does not trickle through the mesh, the reverse side of the mesh may be sealed with a film. The prepared layer may then be compacted, for example, with the aid of a two-roll apparatus (calendar).

The rolling is not particularly restricted and can be effected in a suitable manner. It is optionally possible for this purpose to moisten the respective mixtures, for example to a moisture content of 20% by weight or less, e.g. 5%, 4%, 3%, 2%, 1% by weight or less, based on the respective mixture. Rolling of the mixture or mass (particles) into the structure of the substrate, for example a mesh structure, is explicitly desired in particular embodiments in order to assure high mechanical stability of the electrode and good electrical contact. As a result, in the case of application of multiple layers, the mixtures for the layers may be applied individually to the substrate and then rolled out together in order to achieve better adhesion between the layers.

The mechanical stress on the binder, for example by plastics particles, as a result of the rolling process leads to crosslinking of the powder through the formation of binder channels, for example PTFE fibrils. The attainment of this state is particularly important in order to guarantee a suitable porosity or mechanical stability of the electrode. The hydrophobicity can be adjusted via the respective content of binder, e.g. polymer and optionally ion transport material and/or carrier material, etc., or via the physical properties of the metal M or of the catalyst powder.

The degree of fibrillation of the binder, for example PTFE, (structure parameter correlates directly with the shear rate applied since the binder, for example a polymer, behaves as a shear-thinning (pseudoplastic) fluid on rolling. After the extrusion, the resultant layer has elastic character as a result of the fibrillation. This change in structure is irreversible, and so this effect can no longer subsequently be enhanced by further rolling; instead, the layer is damaged under the further action of shear forces as a result of the elastic characteristics. Particularly significant fibrillation can lead to the electrode rolling up on the layer side, and so excessively high contents of binder should be avoided.

Temperature control of the rolls in the course of rolling can additionally assist the flow process. The temperature range for the rolls may be between room temperature, e.g. 20-25° C., and 200° C., e.g. 20-200° C., e.g. 20-150° C., between 25 and 100° C., for example between 40 and 100° C., or between 60-80° C.

In some embodiments, the rolling or calendering is conducted at a roll speed between 0.3 and 3 rpm, preferably 0.5-2 rpm. In particular embodiments, the flow rate or an advance rate (of the GDE in length per unit time, for example in the course of calendering) Q is in the range from 0.04 to 0.4 m/min, or 0.07 to 0.3 m/min.

For dry rolling, the water content on rolling may correspond, for example, to a maximum of the room humidity. For example, the content of water and solvents on rolling may be less than 5% by weight, less than 1% by weight, and, for example, also 0% by weight.

In some embodiments, the carrier is a mesh, for example comprising the metal M, with a mesh size w of 0.3 mm<w<2.0 mm, 0.5 mm<w<1.4 mm, and a wire diameter x of 0.05 mm<x<0.5 mm, or 0.1 mm≤x≤0.25 mm.

In some embodiments, the bed height y of the first mixture on the carrier on application is in the range from 0.2 mm<y<3.0 mm, or 0.3 mm≤y≤2.0 mm. In the case of multiple layers, each layer may have a corresponding bed height y, but the bed heights of all layers may add up to not more than 3.0 mm, not more than 2 mm, or not more than 1.5 mm. In some embodiments, the layer thickness is below 1 mm, for example below 0.5 mm.

In some embodiments, the roll application is effected by means of a calendar. In particular embodiments, the process described can thus be effected by means of a calendering process, although other production processes are not ruled out. The rolling process itself is characterized in that a reservoir of material forms in front of the roll. In particular embodiments, the gap width in the roll application H₀ is the height of the carrier+40% to 50% of the total bed height Hf of the mixtures of the different layers, for example of the bed height y of the first mixture if that is the only one used, or corresponds virtually to the thickness of the mesh+feed margin 0.1-0.2 mm. The ratio between exit thickness H and gap width Hₒ should preferably be in the region of 1.2.

The material may alternatively also be applied, for example as a suspension, to a commercially available gas diffusion electrode (GDE) (e.g. Freudenberg C2, Sigracet 35 BC) and incorporated therein. Particularly active C₂H₄-evolving electrodes may be obtained, for example, when the catalyst material is sieved onto an existing electrode without an additional binder and bonded thereto.

There follows a description by way of example of specific processes for producing a gas diffusion electrode with two-layer and one-layer construction. Production of a gas diffusion electrode with two-layer construction:

In order to prevent progressive flooding of the hydrophobic regions of the GDE that are required for gas transport, it is possible to use a two-layer construction. For this purpose, for example, a hydrophobic base layer, for example with 15% by weight of PTFE and 85% by weight of powder of the metal M, e.g. Cu or Ag, may be prepared onto the substrate as current distributor, to which a further layer is applied. The extruded base layer here may have a thickness of 50-500 μm, e.g. 100-400 μm. The base layer may be characterized, for example, by a very high conductivity, e.g. <7 mohm/cm, and have a high porosity of, for example, 50-70% and a hydrophobic character. The base layer may itself be catalytically active in the region of the overlap zone with the catalyst layer, the first layer. It serves for better two-dimensional electrical connection of the electrocatalyst and, owing to the high porosity, may improve the availability of gas, for example the CO₂ availability.

With the aid of this method, in particular embodiments, it is possible to reduce the amount of catalyst required by a factor of 20-30. A corresponding electrocatalyst or metal M/binder, e.g. PTFE/ion exchanger mixture, can be sieved onto the base layer in a subsequent step and likewise calendered. The preparation may also commence with the production of the catalyst layer, and binder, e.g. PTFE, can subsequently be applied to the reverse side of the mesh. The binder used, e.g. PTFE, can optionally likewise be pretreated in a knife mill beforehand in order to achieve fiber formation. Illustrative production of the gas diffusion electrode with a binder, e.g. PTFE, based diffusion barrier may be based on multiple layers that should not be considered in isolation from one another, but have a maximum overlap zone in the interface regions, for example 1-20 μm. The total layer thickness of the gas diffusion electrode may be in the range of 100-800 μm, e.g. 200-500 μm.

Production of a Gas Diffusion Electrode with a One-Layer Construction:

In the production of a one-layer catalyst-based electrode, a content of polar ion exchange polymer, if present, may be greatly reduced in order not to adversely affect the gas transport properties or to prevent flooding with electrolyte. For this mode of application, some embodiments include reducing the content of polar ion exchanger to a maximum of 1-20% by weight if this is a direct constituent of the powder mixture. The production can otherwise be effected analogously to the production of a GDE with a two-layer construction.

Some embodiments include a gas diffusion electrode comprising a metal M selected from Ag, Au, Cu and mixtures and/or alloys thereof, wherein the gas diffusion electrode comprises dendritic and amorphous structures. The catalyst material in the gas diffusion electrode of the invention contains both dendritic and amorphous constituents which collectively bring good properties, and it was not available by existing processes. By virtue of the alkaline earth metal, e.g. magnesium, as template in the production process of the invention, it is possible to produce this material. It is not obtainable by the prior art processes. By the production process described herein, morphologies that generate not only the thermodynamic minimum surfaces (111, 100) are obtainable. In particular embodiments, the gas diffusion electrode of the invention comprises thermodynamic minimum surfaces, e.g. {111} and/or {100} and further morphologies having higher indices. For example, a material that has been produced from an Mg₂Cu-rich alloy has a greater degree of presence of the {111} texture, for example of a Cu{111} texture. Such a material shows a high Faraday efficiency for the generation of ethylene of >25%.

In some embodiments, the gas diffusion electrode described herein comprises nanostructures, especially nanodendrites, e.g. having a dendrite diameter of more than 5 nm, of more than 10 nm, or of more than 15 nm, for example 20 nm or more, which can be determined, for example, by means of scanning electron microscopy (SEM) or tunneling electron microscopy (TEM). It is not ruled out here that nanodendrites having diameters of 5 nm or less are also present, provided that the dendrites with a greater diameter are present. The dissolution of an alkaline earth metal-containing, especially alkaline earth metal-rich, e.g. Mg-rich, alloy leads to a higher number of fine catalyst structures of the metal M, e.g. Cu, that can have, for Cu for example, an elevated selectivity for the formation of ethylene. A high alkaline earth metal content, e.g. magnesium content, can lead to complete breakdown of the microstructure. An alloy rich in metal M, for example rich in copper, such as Cu₂Mg, after the alkaline earth metal, for example magnesium, has been leached out, has much coarser porous particles.

In some embodiments, the gas diffusion electrode also includes Cu, Ag and/or Au in the +I valency, e.g. as a compound with O, S, Se, As, Sb, etc., or in the form of an oxide.

In some embodiments, the gas diffusion electrode comprises dendrites containing alkaline earth metal-copper, alkaline earth metal-silver and/or alkaline earth metal-gold phases and/or at least one alkaline earth metal oxide, e.g. MgO. For instance, in the case of partial reaction in the production process of the invention, alkaline earth metal-copper, alkaline earth metal-silver and/or alkaline earth metal-gold phases may remain, for example when the reaction is stopped. If these are then calcined, alkaline earth metal oxides may be formed. These can then lead to a different alignment of the dendrites, such that they need not lie at right angles to the substrate or the base material, as is the case, for example, when dendrites are grown on. The alkaline earth metal oxide here may then be present, for example, on the surface of the dendrites and serve for stabilization.

In some embodiments, the gas diffusion electrode comprises at least one carrier material selected from metal oxides, e.g. Al₂O₃, MgO, TiO₂, Y₂O₃, ZrO₂ and mixtures thereof, where the proportion of the carrier material in the catalyst material is 2% to 40% by weight, 3% to 30% by weight, or even 5% to 10% by weight.

The carrier material here can form mixed oxides with the alkaline earth metal that can further stabilize the gas diffusion electrode and/or the catalyst material. For example, when Mg is present in the material, in the case of addition of TiO₂, oxides such as Mg₂TiO₄ may be integrated into and not just mixed into the metal M, e.g. copper. These can additionally stabilize the +I oxidation state of the metal M, e.g. Cut, which is important for catalysis.

In some embodiments, the gas diffusion electrode further comprises at least one binder and optionally a substrate, as specified, for example, in connection with the production process and as may correspondingly also be present in the gas diffusion electrode described herein.

The electrode may comprise a gas diffusion electrode. The gas diffusion electrode here is not particularly restricted with regard to its configuration, provided that, as usual in gas diffusion electrodes, three states of matter—solid, liquid and gaseous—may be in contact with one another and the solid matter of the electrode includes at least one electron-conducting catalyst that can catalyze an electrochemical reaction between the liquid phase and the gaseous phase. The gas diffusion electrodes here may be operated either in a flow-by or a flow-through configuration, i.e. a gas may flow past or through them, but may flow past them. It is also not ruled out that a gas diffusion electrode may not be completely porous but may have merely structuring at the surface through which a gas can diffuse, for example micro- and/or nanostructuring.

For example, in particular embodiments, there are hydrophobic channels and/or pores or regions and optionally hydrophilic channels and/or pores or regions on the electrolyte side in the gas diffusion electrode (GDE), where catalyst centers may be present in the hydrophilic regions. On a gas side of the gas diffusion electrode, this may comprise hydrophobic channels and/or pores. In this respect, the gas diffusion electrode may comprise at least two sides, one with hydrophilic and optionally hydrophobic regions and one with hydrophobic regions.

Particularly active catalyst centers are present in a GDE in the liquid/solid/gaseous three-phase region. An ideal GDE thus has maximum penetration of the bulk material by hydrophilic and hydrophobic channels and/or pores in order to obtain a maximum number of three-phase regions for active catalyst centers.

In particular embodiments, the gas diffusion electrode comprises or consists of metal M, optionally at least one salt of the metal M, and at least one binder.

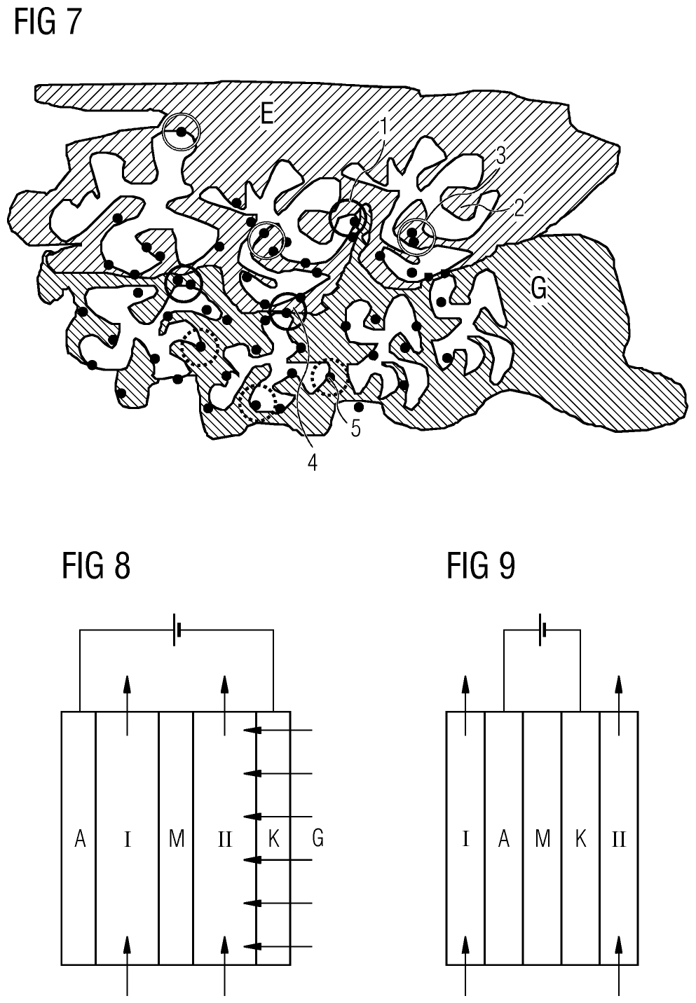

FIG. 7 illustrates the relationships between hydrophilic and hydrophobic regions of an illustrative GDE with two layers, which can achieve a good liquid/solid/gaseous three-phase relationship. In this case, there are hydrophobic channels or regions 1 and hydrophilic channels or regions 2 on the electrolyte side E in the electrode, for example, where catalyst centers 3 of lower activity may be present in the hydrophilic regions 2, and these may be provided by the bonding of the metal M. In addition, there are inactive catalyst centers 5 on the side of the gas G that have no access to the electrolyte.

Particularly active catalyst centers 4 are in the liquid/solid/gaseous three-phase region. An ideal GDE may thus have maximum penetration of the bulk material with hydrophilic and hydrophobic channels in order to obtain a maximum number of three-phase regions for active catalyst centers.

In some embodiments, gas diffusion electrodes include just one layer, provided that the gas diffusion electrode comprises the metal M, the at least one binder and optionally the at least one salt of the metal M. In such a one-layer embodiment, it is then also possible for the hydrophilic and hydrophobic regions, for example pores and/or channels, to be present in the one layer, such that predominantly hydrophilic and predominantly hydrophobic regions may be established in the layer. In that case, the elucidation of the catalyst centers here is analogous to the two-layer construction presented by way of example.

In some embodiments, the gas diffusion electrode has pores and/or channels having a diameter of 10 nm to 100 μm, of 50 nm to 50 μm, or of 100 nm to 10 μm, which can be determined, for example, by scanning electron microscopy, optionally after prior cutting of the GDE. In some embodiments, average pore sizes have been found to be in the range of 0.4-5 μm or in the range of 0.5-2 μm.

The catalyst of the present GDE that may comprise the metal M and cations thereof, e.g. M⁺, may have dendritic structures with fine structure, for example a distance between two dendrites, having a size of 1 to 100 nm, 2 to 20 nm, or 3 to 10 nm.

As well as the metal M, optionally the at least one salt thereof and the at least one binder, the electrode may also comprise further constituents, for example a substrate to which the metal M, optionally the at least one salt thereof and the at least one binder, may be applied. It is also possible to apply more than one layer, for example two, three, four or more, to the substrate.

The substrate here is not particularly restricted and may comprise, for example, a metal such as silver, platinum, nickel, lead, titanium, nickel, iron, manganese, copper, gold and/or chromium and/or alloys thereof, such as stainless steels, and/or at least one nonmetal, such as carbon, Si, boron nitride (BN), boron-doped diamond, etc., and/or at least one conductive oxide such as indium tin oxide (ITO), aluminum zinc oxide (AZO) or fluorinated tin oxide (FTO), and/or at least one polymer based on polyacetylene, polyethoxythiophene, polyaniline or polypyrrole, for example in polymer-based electrodes. Nonconductive substrates, for example polymer meshes, are possible, for example, given a sufficient conductivity of the catalyst layer. Given a sufficient conductivity of greater than 0.01 m/ohm·mm² and appropriately resolved reverse-side contacting of the electrode, for example by means of an expanded titanium metal mesh, polymeric substrates or meshes are also possible.

In some embodiments, the substrate may, however, be formed essentially by the metal M, optionally with at least one binder. In some embodiments, a substrate comprises a mesh having a mesh size w of 0.3 mm<w<2.0 mm, 0.5 mm<w<1.4 mm, and a wire diameter x of 0.05 mm<x<0.5 mm, or 0.1 mm≤x≤0.25 mm.

In addition, a layer formed from the metal M, optionally the at least one salt thereof and the at least one binder may also contain further promoters that improve the catalytic activity of the GDE in association with the metal M. In some embodiments, the first layer contains at least one metal oxide which has a lower reduction potential than the evolution of ethylene, e.g. ZrO₂, Al₂O₃, CeO₂, Ce₂O₃, ZnO₂, MgO; and/or at least one metal-rich (based on M), e.g. copper-rich and/or silver-rich and/or gold-rich, intermetallic phase, for example a Cu-rich phase selected from the group of the binary systems Cu—Al, Cu—Zr, Cu—Y, Cu—Hf, Cu—Ce, Cu—Mg and the ternary systems Cu—Y—Al, Cu—Hf—Al, Cu—Zr—Al, Cu—Al—Mg, Cu—Al—Ce with Cu contents of >60 at. %, and/or a corresponding Ag-rich phase such as Ag—Al, Ag—Zr, Ag—Y, Ag—Hf, Ag—Ce, Ag—Mg, Ag—Y—Al, Ag—Hf—Al, Ag—Zr—Al, Ag—Al—Mg, Ag—Al—Ce with Ag contents of <60 at. %; and/or metal M-containing, for example silver-containing, gold-containing and/or copper-containing, perovskites and/or defect perovskites and/or perovskite-related compounds, for example YBa₂Cu₃O_{7-δ}, YBa₂Ag₃O_{7-δ} where 0≤δ≤1 (corresponding to YBa₂Cu₃O_{7-δ}X_{σ}), CaCu₃Ti₄O₁₂, La_{1.85}Sr_{0.15}CuO_{3.930}Cl_{0.053}, (La, Sr)₂CuO₄, AgTaO3 or lithium-modified Ag₁₋ₓLiₓNbO₃, etc.

Suitable promoters include compounds of the metal M that have a solubility in water at 25° C. and standard pressure of less than 0.1 mol/L, less than 0.05 mol/L, less than 0.01 mol/L, or even less than 0.0001 mol/L, less than 1*10⁻¹⁰ mol/L, for example of less than 1*10⁻²⁰ mol/L. Such solubilities of compounds of the metal M can be found, for example, in product data sheets and/or can be determined in a simple manner by simple experiments, for example placing of a fixed amount of the compound of the metal M into a particular volume of water, for example distilled, bidistilled or triply distilled water at 25° C. and standard pressure, and measuring the concentration of ions released from the compound over time until attainment of an approximately constant value, and are consequently readily obtainable by a person skilled in the art.

The compound of the metal M that has a solubility in water at 25° C. and standard pressure of less than 0.1 mol/L may have a formula selected from M₁₋ₓX, M_{2-y}Y, M_{2-y}Y′_{w} and M_{3-z}Z, where 0≤x≤0.5; 0≤y≤1; 0≤z≤1.5; 0≤x≤0.4; 0≤y≤0.8; 0≤z≤1.2; or 0≤x≤0.3; 0≤y≤0.6; 0≤z≤0.9; X is selected from Cl, Br, Br₃, I, I₃, P₃, As₃, As₅, As₇, Sb₃, Sb₅, Sb₇, and mixtures thereof, e.g. Cl, Br, Br₃, I, I₃, P₃, and mixtures thereof; Y is selected from S, S, Te and mixtures thereof; Y′ is selected from S, Se, Te and mixtures thereof, e.g. S, Se and mixtures thereof, e.g. S, Se; w≥2, or w≤10, e.g. w≤5; and Z is selected from P, As, Sb, Bi, P₃, As₃, As₅, As₇, Sb₃, Sb₅, Sb₇, and mixtures thereof, e.g. P, As, Sb, Bi, and mixtures thereof; and/or is selected from molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M; and/or compounds of the formula MₐX_{b}Y_{c}Z_{d} where a≥2, e.g. a≥3; 0≤b≤4, e.g. 0≤b≤3, e.g. 0≤b≤2, e.g. 0≤b≤1; 0≤c≤8, e.g. 0≤c≤6, e.g. 0≤c≤5, e.g. 0≤c≤4, e.g. 0≤c≤3, e.g. 0≤c≤2, e.g. 0≤c≤1; 0≤d≤4, e.g. 0≤d≤3, e.g. 0≤d≤2, e.g. 0≤d≤1; X is selected from Cl, Br, Br₃, I, I₃, P₃, As₃, As₅, As₇, Sb₃, Sb₅, Sb₇, and mixtures thereof, e.g. Cl, Br, Br₃, I, I₃, P₃, and mixtures thereof; Y is selected from S, S, Te and mixtures thereof; and Z is selected from P, As, Sb, Bi, P₃, As₃, As₅, As₇, Sb₃, Sb₅, Sb₇, and mixtures thereof, where at least two of b and c are not simultaneously 0.

The compound of the metal M that has a solubility in water at 25° C. and standard pressure of less than 0.1 mol/L thus need not be stoichiometric here either and may also have mixed phases. Also included are ternary, quaternary etc. compounds, for example Ag₃SbS₃, pyrargyrite, and Ag₃AsS₃, xanthoconite.

In some embodiments, the compound of the metal M that has a solubility in water at 25° C. and standard pressure of less than 0.1 mol/L is a compound of the formula Ia: M₁₋ₓX where 0≤x≤0.5; 0≤x≤0.4; or 0≤x≤0.3, and X is selected from Cl, Br, Br₃, I, I₃, P₃, As₃, As₅, As₇, Sb₃, Sb₅, Sb₇, and mixtures thereof, e.g. Cl, Br, Br₃, I, I₃, P₃, and mixtures thereof, for example including mixtures of Cl, Br, I, for example a compound of the formula I′a: Ag₁₋ₓX with X=F, Cl, Br, Br₃, I, I₃, P₃, As₃, As₅, As₇, Sb₃, Sb₅, Sb₇, or a mixture thereof, e.g. X=F, Cl, Br, Br₃, I, I₃, P₃, or a mixture thereof, e.g. a mixture of Cl, Br and/or I. Particularly some of the latter compounds of silver are photosensitive. Photo-surface activation of the electrode prior to insertion is, however, not ruled out. For operation, however, this is usually immaterial since the electrodes in the electrolyzer are not exposed to daylight. Substoichiometric compounds with 0<x≤0.5; 0<x≤0.4; or 0<x≤0.3; e.g. 0<x≤0.2; 0<x≤0.1 are likewise suitable. In particular embodiments, x=0. Examples of the compound Ia are, for example, AgCl, AgBr, AgI, AgP₃, CuCl, CuBr, CuI, AuCl, AuBr, AuI.

In some embodiments, the compound of the metal M that has a solubility in water at 25° C. and standard pressure of less than 0.1 mol/L is a chalcogen-based compound of the formula Ib: M_{2-y}Y, or I*: M_{2-y}Y′_{w}, where 0≤y≤1; preferably 0≤y≤0.8; or 0≤y≤0.6; Y is selected from S, S, Te and mixtures thereof; Y′ is selected from S, Se, Te and mixtures thereof, e.g. S, Se and mixtures thereof, e.g. S, Se; and w 2, w 10, e.g. w 5, e.g. a compound of the formula I′b: Ag_{2-y}Y or I*′b: Ag_{2-y}Y′_{w} with Y=S, Se, Te or a mixture thereof; Y′=S, Se, Te or a mixture thereof, e.g. S, Se or a mixture thereof, e.g. S, Se; w≥2, preferably w≤10, e.g. w 5. The context of the invention thus also includes the polymeric or oligomeric anions of sulfur or selenium Y′_{w}²⁻. Some of these compounds are semiconductive, such that an electrical coupling to the silver catalyst can be assured. Substoichiometric compounds with 0<y≤1; 0<y≤0.8; or 0<y≤0.6; e.g. 0<x≤0.4; 0<x≤0.2; 0<x≤0.1 are likewise suitable. In particular embodiments, y=0. Examples of the compound of the formula Ib are, for example, Ag₂S, Ag₂Se, Ag₂Te, Cu₂S, Cu₂Se, Cu₂Te, Au₂S, and examples of the compound of the formula I′b are, for example, Ag₂(S₂), Ag₂(Se₂), Cu₂(S₂), Cu₂(Se₂), etc.

In some embodiments, the compound of the metal M that has a solubility in water at 25° C. and standard pressure of less than 0.1 mol/L is a compound of the formula Ic: M_{3-z}Z, where 0≤z≤1.5; 0≤z≤1.2; or 0≤z≤0.9; and Z is selected from P, As, Sb, Bi, P₃, As₃, As₅, As₇, Sb₃, Sb₅, Sb₇, and mixtures thereof, e.g. a compound of the formula I′ c: Ag_{3-z}Z with Z=P, As, Sb, Bi, P₃, As₃, As₅, As₇, Sb₃, Sb₅, Sb₇, or a mixture thereof. Some of these compounds are semiconductive or metallically conductive, such that an electrical coupling to the silver catalyst can be assured. Substoichiometric compounds with 0<z≤1.5; 0<z≤1.2; or 0<z≤0.9; e.g. 0<x≤0.6; 0<x≤0.4; 0<x≤0.2; 0<x≤0.1 are likewise suitable. In particular embodiments, z=0. Examples of the compound of the formula Ic are, for example, Ag₃P, Ag₃As, Ag₃Sb, Ag₃Bi, Cu₃P, Cu₃As, Cu₃Sb, Cu₃Bi.

Some embodiments include compounds of the metal M having a solubility in water at 25° C. and standard pressure of less than 0.1 mol/L with heavy anions such as molybdate, tungstate, arsenate, selenate, vanadate, chromate, manganate in various oxidation states, niobate or thio and/or seleno derivatives thereof. These anions may also be in polymeric form in the form of polyoxometalates. These are then used primarily in the form of their silver salts. Likewise encompassed are mineral compounds of the metal M, for example of the formula MₐX_{b}Y_{c}Z_{d}, where a≥2, e.g. a≥3; 0≤b≤4, e.g. 0≤b≤3, e.g. 0≤b≤2, e.g. 0≤b≤1; 0≤c≤8, e.g. 0≤c≤6, e.g. 0≤c≤5, e.g. 0≤c≤4, e.g. 0≤c≤3, e.g. 0≤c≤2, e.g. 0≤c≤1; 0≤d≤4, e.g. 0≤d≤3, e.g. 0≤d≤2, e.g. 0≤d≤1; X is selected from Cl, Br, Br₃, I, I₃, P₃, As₃, As₅, As₇, Sb₃, Sb₅, Sb₇, and mixtures thereof, e.g. Cl, Br, Br₃, I, I₃, P₃, and mixtures thereof; Y is selected from S, S, Te and mixtures thereof; and Z is selected from P, As, Sb, Bi, P₃, As₃, As₅, As₇, Sb₃, Sb₅, Sb₇, and mixtures thereof, e.g. P, As, Sb, Bi, and mixtures thereof, where at least two of b and c are not simultaneously 0, e.g. AgSbS₃, pyrargyrite, and Ag₃AsS₃, xanthoconite.

The compounds of the metal M having a solubility in water at 25° C. and standard pressure of less than 0.1 mol/L that are mentioned in the context of the invention may occur in different polymorphs that may differ in terms of their crystal structure. As well as the compounds described, for example, also known are the following ternary compounds: Ag₃SbS₃, pyrargyrite, Ag₃AsS₃, xanthoconite, which may be used in gas diffusion electrodes of the invention.

In some embodiments, promoters include metal oxides and/or compounds of the metal M that have a solubility in water at 25° C. and standard pressure of less than 0.1 mol/L. The metal oxide used and/or the compound of the metal M having a solubility in water at 25° C. and standard pressure of less than 0.1 mol/L, in particular embodiments, may be water-insoluble, in order that aqueous electrolytes can be used in an electrolysis using the gas diffusion electrode.

Moreover, by virtue of the redox potential of the metal oxide being lower than that of the evolution of ethylene, it can be ensured that ethylene can be prepared from CO₂ by means of the GDE. In some embodiments, the oxides are also not to be reduced in a carbon dioxide reduction. Nickel and iron, for example, are unsuitable since hydrogen forms here. Furthermore, the metal oxides may not be inert but may constitute hydrophilic reaction centers that can serve for the provision of protons.

The promoters, especially the metal oxide and/or the compound of the metal M having a solubility in water at 25° C. and standard pressure of less than 0.1 mol/L can promote the function and production of electrocatalysts of prolonged stability here, in that they stabilize catalytically active metal (M) nanostructures, for example of Cu and/or Ag. The structural promoters here can reduce the high surface mobilities of the nanostructures and hence their tendency to sinter.

Promoters used for the electrochemical reduction of CO₂ may be in particular the following metal oxides that cannot be reduced to metals within the electrochemical window: ZrO₂ (E=−2.3 V), Al₂O₃ (E=−2.4 V), CeO₂ (E=−2.3 V), MgO (E=−2.5). It should be noted here that the oxides mentioned are not added as additives but are part of the catalyst itself. As well as its function as promoter, the oxide also fulfills the feature of stabilizing the metal M, e.g. Cu and/or Ag and/or Au, in the I oxidation state and additionally also intermediates in carbon dioxide reduction such as CO, C₂H₄ (or OH).

It is possible to achieve the following effects: the metal oxide, owing to its high specific surface area, can lead to better distribution of the catalyst metal M; highly dispersed metal centers can be stabilized by the metal oxide; a gas, e.g. CO₂, chemisorption can be improved by the metal oxide; metal oxides of the metal M, for example of Cu, Ag, can be stabilized.

The precipitation may be followed by drying with subsequent calcination in an O₂/Ar gas stream. The oxide precursors generated, according to the method, may also be reduced directly thereafter in an H₂/Ar gas stream. The activation step can also be effected subsequently by electrochemical means. In order to improve the electrical conductivity of the layer applied prior to the electrochemical activation, it is also possible to some degree to mix oxide precursors and activated precursors. It is likewise not ruled out that the ready-calendered electrode may be subjected to a subsequent calcination/thermal treatment before the electrochemical activation is conducted.

A further means of production of suitable electrocatalysts is based on the approach of the generation of intermetallic phases rich in metal M, for example Cu₅Zr, Cu₁₀Zr₇, Cu₅₁Zr₁₄, Ag₅Zr, Ag₁₀Zr₇, Ag₅₁Zr₁₄ which can be produced from the melt. Corresponding ingots can be ground subsequently and calcined partly or completely in an O₂/argon gas stream and converted to the oxide form. Illustrative phases rich in metal M are binary Cu—Al, Cu—Zr, Cu—Y, Cu—Hf, Cu—Ce, Cu—Mg systems and corresponding ternary systems with contents of metal M>60 at. %: CuYAl, CuHfAl, CuZrAl, CuAlMg, CuAlCe and/or corresponding Ag-rich phases such as Ag—Al, Ag—Zr, Ag—Y, Ag—Hf, Ag—Ce, Ag—Mg, Ag—Y—Al, Ag—Hf—Al, Ag—Zr—Al, Ag—Al—Mg, Ag—Al—Ce with Ag contents of <60 at. %. Copper-rich phases are known, for example, from E. Kneller, Y. Khan, U. Gorres, The Alloy System Copper-Zirconium, Part I. Phase Diagram and Structural Relations, Zeitschrift für Metallkunde 77 (1), p. 43-48, 1986 for Cu—Zr phases, from Braunovic, M.; Konchits, V. V.; Myshkin, N. K.: Electrical contacts, fundamentals, applications and technology; CRC Press 2007 for Cu—Al phases, from Petzoldt, F.; Bergmann, J. P.; SchUrer, R.; Schneider, 2013, 67 Metall, 504-507 for Cu—Al phases, from Landolt-Börnstein—Group IV Physical Chemistry Volume 5d, 1994, p. 1-8 for Cu—Ga phases, and from P. R. Subramanian, D. E. Laughlin, Bulletin of Alloy Phase Diagrams, 1988, 9, 1, 51-56 for Cu—Hf phases, to which reference is hereby made with regard to these phases and the content of which at least in this regard is hereby incorporated into this application by reference.

The proportion of metal M, e.g. Cu, Ag, is preferably greater than 40 at. %, greater than 50 at. %, or greater than 60 at. %. However, it is not ruled out here that the intermetallic phases may also contain nonmetal elements such as oxygen, nitrogen, sulfur, selenium and/or phosphorus, i.e., for example, oxides, sulfides, selenides, nitrides, and/or phosphides, arsenides, antimonides, bismuthides are present. In some embodiments, the intermetallic phases are partly oxidized.

In addition, the following copper-containing perovskite structures and/or defect perovskites and/or perovskite-related compounds may be used for electrocatalysts, especially for the formation of CO or hydrocarbons: YBa₂Cu₃O_{7-δ,} where 0≤δ≤1, CaCu₃Ti₄O₁₂, La_{1.85}Sr_{0.15}, CuO_{3.930}Cl_{0.053}, (La,Sr)₂CuO₄, AgTaO₃ or lithium-modified Ag₁₋ₓLiₓNbO₃. In addition, it is not ruled out that mixtures of these materials can be used for electrode preparation or, as required, subsequent calcination or activation steps are conducted.

With regard to promoters and suitable metals M or metal oxides and structures thereof, reference is hereby also made to DE 102015203245.0 or DE 102015215309.6, the content of which at least in this regard is hereby incorporated into this application by reference.

Particularly active and CO- or C₂H₄-selective gas diffusion electrodes for a CO₂ and/or CO electrolysis are to fulfill a multitude of parameters for selective product formation. There follows a presentation of specific properties of particular embodiments of an electrode. Specific embodiments of the catalyst allow the electrode to selectively form products.

The following specific parameters and requirements for a hydrocarbon-selective gas diffusion electrode have been found:
Accessibility of the catalyst particles by reactant gas, e.g. CO₂ and/or CO, via predominantly hydrophobic pores
Predominantly hydrophilic regions that enable contact between electrolyte and catalyst particles
Sufficiently high electrical conductivity of the electrode or catalyst and a homogeneous potential distribution across the entire electrode area (potential-dependent product selectivity)
High chemical and mechanical stability in electrolysis operation (suppression of cracking and corrosion)
Defined porosity with a suitable ratio between hydrophilic and hydrophobic channels or pores in close proximity (assurance of availability of CO and/or CO₂ with simultaneous presence of H⁺ ions)
Good wettability of the electrode surface in order that the aqueous electrolyte or H⁺ ions can come into contact with the catalyst (H⁺ is required for ethylene)
The ratio between hydrophilic and hydrophobic pore volume should preferably be in the region of about 0.1-0.5:3 and preferably about 0.2:3.

In some embodiments, all particles present may be part of the three-phase boundary in order to be able to achieve high current densities. The pore system, especially for copper, may have sufficient absorption of intermediates to assure further reaction or dimerization/oligomerization.

Furthermore, the following properties for the electrocatalyst formed from the metal M and a cationic form thereof, especially M⁺, for an electrochemical reduction, especially of CO₂ to ethylene may be useful:
uniform particle size, e.g. with high specific surface area
dendritic morphology, no isolated centers or clusters
the metal M, e.g. Ag, Cu, should not be in a pure cubic face-centered lattice, but should have structure defects
the presence of a monovalent oxide, e.g. Cu₂O for Cu, Ag₂O for Ag, of the metal M is advantageous for ethylene selectivity; the formation of higher-valency oxides may be avoided.
structure defects can be stabilized using electrochemically stable oxides
high purity without extraneous metal traces, especially of transition metals, and carbon constituents (soots, cokes)
high selectivity and long-term stability
low overvoltage with respect to the gas reduction, e.g. CO₂ reduction
high overvoltage for the formation of hydrogen.

For CO or hydrocarbon-selective gas diffusion electrodes in a reduction of CO₂ and/or CO, accordingly, more intrinsic properties are needed than are offered by known systems. The electrocatalyst and the electrode are accordingly in close interplay. In some embodiments, the gas diffusion electrode of the invention comprises a substrate, preferably in the form of a sheetlike structure, and a layer comprising the metal M, optionally at least one salt thereof and at least one binder, wherein the layer comprises hydrophilic and hydrophobic pores and/or channels. It is not ruled out here that the layer may contain further constituents, for example an ion transport material.

In some embodiments, the gas diffusion electrode comprises a substrate, e.g. in the form of a sheetlike structure, a first layer comprising the metal M, optionally at least one salt thereof and optionally at least one binder, wherein the first layer comprises hydrophilic and optionally hydrophobic pores and/or channels, and also a second layer comprising the metal M, optionally at least one salt thereof and at least one binder, where the second layer is atop the carrier and the first layer atop the second layer, where the content of binder in the first layer may be less than in the second layer, where the second layer comprises hydrophobic pores and/or channels, maybe where the second layer includes 3-30% by weight of binder, 4-28% by weight of binder, or 5-20% by weight of binder, for example 10-20% by weight of binder, based on the second layer, and the first layer may include 0-20% by weight of binder, 0.1-15% by weight of binder, 1-12% by weight of binder, or 5-10% by weight of binder (e.g. PTFE), based on the first layer.

In the first and second layers, it may be the case, for example, in particular embodiments, that the proportion of metal M, any salt thereof and binder add up to 100% by weight in each case. It is not ruled out here that the layers may contain further constituents, for example an ion transport material; preferably, however, at least the second layer facing the gas side does not contain any ion transport material.

Some embodiments include a gas diffusion electrode produced by the process described herein. In this context, this especially has the properties possessed by the gas diffusion electrode in the second aspect. Through the use of the copper-, silver- and/or gold-containing starting material comprising at least one alkaline earth metal-copper, alkaline earth metal-silver and/or alkaline earth metal-gold phase, where the alkaline earth metal is selected from Mg, Ca, Sr, Ba and mixtures thereof, it is possible to obtain a gas diffusion electrode having dendritic and amorphous structures.

Some embodiments include an electrolysis cell comprising the gas diffusion electrode. Additionally disclosed is an electrolysis cell comprising a gas diffusion electrode, e.g. as cathode, an anode and optionally at least one membrane and/or at least one diaphragm between the cathode and anode. In some embodiments, the electrolysis cell of the invention further comprises an anode and at least one membrane and/or at least one diaphragm between the cathode and anode.

The further constituents of the electrolysis cell, for instance the anode, optionally a membrane and/or a diaphragm, inlet(s) and outlet(s), the power source, etc., and further optional devices such as cooling or heating units, are not particularly restricted, nor are anolytes and/or catholytes that are used in such an electrolysis cell, where the electrolysis cell, in particular embodiments, is used on the cathode side for reduction of carbon dioxide and/or CO. The configuration of the anode space and of the cathode space is likewise not particularly restricted.

First illustrative configurations for an illustrative construction of general electrolysis cells and/or possible anode spaces and cathode spaces are shown in FIGS. 8 to 11. An electrochemical reduction of CO₂ and/or CO, for example, takes place in an electrolysis cell that typically consists of an anode and a cathode space. FIGS. 8 to 11 which follow show examples of a possible cell arrangement. For each of these cell arrangements it is possible to use a gas diffusion electrodes described herein, for example as cathode K. FIGS. 8 to 11 show, by way of example, membranes M, for example ion-selective membranes, for separation of catholyte and anolyte, but these may also be supplemented or replaced, for example, by diaphragms.

By way of example, the cathode space II in FIG. 8 is configured such that a catholyte is supplied from the bottom, and it leaves the cathode space II at the top. In some embodiments, the catholyte may also be supplied from the top, as for example in the case of falling-film electrodes. It is possible to supply CO₂ and/or CO, for example, via the gas diffusion electrode K, and this can be conveyed through the porous gas diffusion electrode as cathode K—as shown—into the cathode space II for reduction. At the anode A which is electrically connected to the cathode K by means of a power source for provision of the voltage for the electrolysis, the oxidation of a substance which is supplied from the bottom, for example with an anolyte, takes place in the anode space I, and the anolyte then leaves the anode space with the oxidation product.

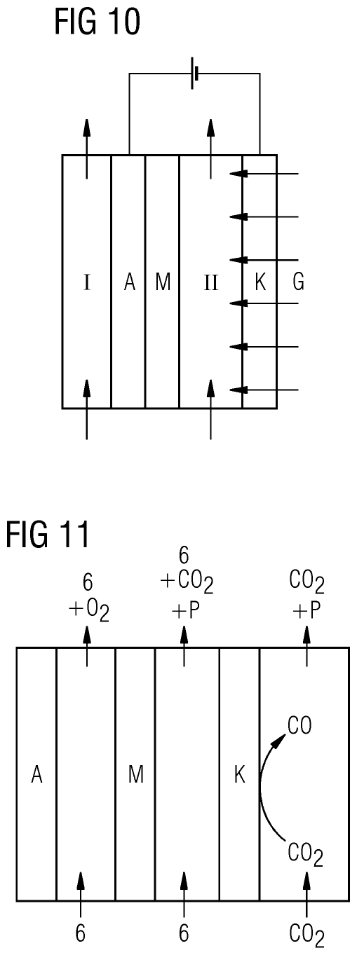

Although they are not shown, embodiments with a porous anode are also possible. In FIG. 8, the spaces I and II are separated by a membrane M. By contrast, in the PEM (proton or ion exchange membrane) construction of FIG. 9, a porous cathode K and a porous anode A directly adjoin the membrane M, which results in separation of the anode space I from the cathode space II. The construction in FIG. 10 corresponds to a mixed form of the construction from FIG. 8 and the construction from FIG. 9, with provision of a structure with a gas diffusion electrode on the catholyte side, as shown in FIG. 8, whereas a construction as in FIG. 9 is provided on the anolyte side.

In some embodiments, mixed forms or other configurations of the electrode spaces shown by way of example are possible. Also conceivable are embodiments without a membrane. In particular embodiments, the electrolyte on the cathode side and the electrolyte on the anode side may thus be identical, and the electrolysis cell/electrolysis unit may not need a membrane. Sufficient gas separation can then be achieved, for example, by appropriate construction of the electrolysis cell. However, it is not ruled out that the electrolysis cell in such embodiments may have a membrane and/or a diaphragm or multiple membranes and/or diaphragms, for example 2, 3, 4, 5, 6 or more membranes and/or diaphragms that may be the same or different, but this may be associated with additional expenditure with regard to the membrane and also the voltage applied.

Catholyte and anolyte may also optionally be mixed again outside the electrolysis cell. Flow-by operation is also possible in an electrolysis cells, in which case the electrolysis cell may also have a construction as shown in FIG. 11. In FIG. 11, it is then possible here for the CO2 shown by way of example to diffuse through the gas diffusion electrode and arrive at the catholyte, where catholyte and anolyte are shown identically here by way of example as electrolyte 6 and the output of products P is also shown.

FIGS. 8 to 11 are schematic diagrams. The electrolysis cells from FIGS. 8 to 11 may also be combined to give mixed variants. For example, the anode space may be executed as a PEM half-cell, as in FIG. 9, while the cathode space consists of a half-cell that includes a certain electrolyte volume between membrane and electrode.

In some embodiments, the distance between electrode and membrane and/or diaphragm is very small or 0 when the membrane and/or diaphragm is in porous form and includes a feed of the electrolyte. The membrane and/or diaphragm may also be in multilayer form, such that separate feeds of anolyte and catholyte are enabled. Separation effects can be achieved in the case of aqueous electrolytes, for example, via the hydrophobicity of interlayers and/or an appropriate adjustment of the prevailing capillary forces. Conductivity can nevertheless be assured when conductive groups are integrated into such separation layers. The membrane and/or diaphragm may be an ion-conducting membrane and/or an ion-conducting diaphragm, or a separator that results in merely a mechanical separation and is permeable to cations and anions.

The electrode may comprise a gas diffusion electrode that enables construction of a three-phase electrode. For example, a gas may be guided from the back to the electrically active front side of the electrode in order to conduct the electrochemical reaction there. In particular embodiments, the gas diffusion electrode may also be merely in flow-by mode, meaning that a gas such as CO₂ and/or CO is guided past the reverse side of the gas diffusion electrode in relation to the electrolyte, in which case the gas can penetrate through the pores of the gas diffusion electrode and the product can be removed at the back. It has been found that, even though a gas such as CO₂ does not “bubble” through the electrolyte, similarly high Faraday efficiencies (FE) of products are nevertheless found. For example, the gas flow in the case of flow-by operation may also be reversed relative to the electrolyte flow, in order that any liquid forced through can be transported away. A gap may be between the gas diffusion electrode and the membrane as electrolyte reservoir.

The supply of a gas can additionally also be accomplished in a different way for the gas diffusion electrode shown in FIG. 9, for example in the case of supply of CO₂ and/or CO. By virtue of the gas, e.g. CO₂, being conducted through the electrode in a controlled manner, it is again possible to rapidly discharge the reaction products.

In some embodiments, the electrolysis cell has a membrane and/or a diaphragm that separates the cathode space and the anode space of the electrolysis cell, in order to prevent mixing of the electrolytes. The membrane and/or diaphragm here are not particularly restricted, provided that they separate the cathode space and the anode space. More particularly, it essentially prevents passage of the gases formed at the cathode and/or anode to the respective anode space or to the cathode space. In some embodiments, the membrane comprises an ion exchange membrane, for example a polymer-based ion exchange membrane. In some embodiments, the material for an ion exchange membrane is a sulfonated tetrafluoroethylene polymer such as Nafion®, for example Nafion® 115. As well as polymer membranes, ceramic membranes may also be employed, for example the polymers that are mentioned in EP 1685892 A1 and/or laden with zirconium oxide, e.g. polysulfones. In some embodiments, the electrolysis cell comprises or more, for example 3, 4, 5, 6 or more, membranes and/or diaphragms, where electrolyte spaces may be provided between the different membranes and/or diaphragms and/or the membranes and/or diaphragms and the electrodes.

Furthermore, the anode material is not particularly restricted and depends primarily on the desired reaction. Illustrative anode materials include platinum or platinum alloys, palladium or palladium alloys, and glassy carbon. Further anode materials are also conductive oxides such as doped or undoped TiO2, indium tin oxide (ITO), fluorine-doped tin oxide (FTO), aluminum-doped zinc oxide (AZO), iridium oxide, etc. These catalytically active compounds may also have been merely superficially applied by thin-film methodology, for example on a titanium and/or carbon carrier.

The production technique described may constitute the basis for the production of electrodes in a larger scale that can achieve current densities >200 mA/cm² according to the mode of operation. Methods known to date for production of ethylene-selective Cu electrodes are typically not suitable for scaleup or are not dimensionally stable, but the same is true of other electrolysis cells for reduction of CO₂ and/or CO. The gas diffusion electrode GDE enables electrolysis operation with prolonged stability of a catalyst-based GDE in the cell arrangements shown in FIGS. 8 to 11 at high current densities in saline electrolytes.

The anode reaction in the electrolysis cell is in no way limited to oxygen production. Further examples are peroxodisulfate formation or chlorine production.

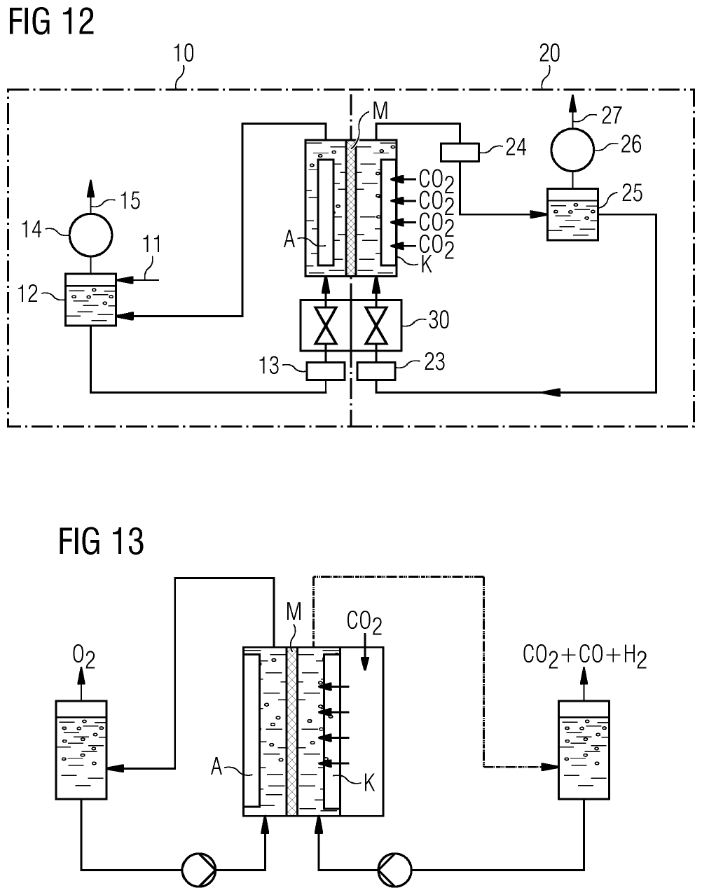

In some embodiments, an electrolysis system comprises the gas diffusion electrode described herein or the electrolysis cell described herein. An abstract diagram of an electrolysis system incorporating the teachings herein is shown in FIG. 12.

FIG. 12 shows, by way of example, an electrolysis in which carbon dioxide and/or CO is reduced on the cathode side and water is oxidized on the anode A side, although other reactions may also proceed, for example on the anode side. On the anode side, it would be possible in further examples for a reaction of chloride to give chlorine, bromide to give bromine, sulfate to give peroxodisulfate (with or without evolution of gas), etc. to take place. Examples of suitable anodes A include platinum or iridium oxide on a titanium carrier, and examples of suitable cathodes K include the gas diffusion electrode for reduction of CO₂ and/or CO, for example based on Cu. The two electrode spaces of the electrolysis cell are separated by a membrane M, for example of Nafion®. The incorporation of the cell into a system with anolyte circuit 10 and catholyte circuit 20 is shown in schematic form in FIG. 12.

On the anode side, in this illustrative embodiment, water with electrolyte additions is fed via an inlet 11 into an electrolyte reservoir vessel 12. However, it is not ruled out that water may be fed in, in addition to or instead of the inlet 11, at another point in the anolyte circuit 10, since, according to FIG. 12, the electrolyte reservoir vessel 12 is also used for gas separation. The water is pumped out of the electrolyte reservoir vessel 12 by means of the pump 13 into the anode space, where it is oxidized. The product is then pumped back into the electrolyte reservoir vessel 12, where it can be led off into the product gas vessel 14. The product gas can be removed from the product gas vessel 14 via a product gas outlet 15. The product gas can of course also be separated off elsewhere, for example in the anode space as well. The result is thus an anolyte circuit 10 since the electrolyte is being conducted in a cycle on the anode side.

On the cathode side, carbon dioxide and/or CO is introduced to the catholyte circuit 20 via the cathode K, which is configured here as the gas diffusion electrode of the invention. It is possible here for the CO₂ and/or CO to be supplied, for example, in flow-by or flow-through mode of the gas diffusion electrode. By means of a pump 23, catholyte is brought into the cathode space, with reduction of the carbon dioxide and/or CO at the cathode K. An optional further pump 24 then pumps the solution obtained at the cathode K, for example, further to a vessel for gas separation 25—for example when the cathode is in flow-through mode—in which a product gas can be led off into a product gas vessel 26. The product gas can be withdrawn from the product gas vessel 26 via a product gas outlet 27.

The electrolyte is in turn pumped out of the vessel for gas separation back to the cathode space, where carbon dioxide and/or CO can be reacted again. Here too, merely an illustrative arrangement of a catholyte circuit 20 is specified, wherein the individual apparatus components of the catholyte circuit 20 may also be arranged differently, for example in that the gas separation is already effected in the cathode space. The gas that exits from the cathode space may, in particular embodiments, consist to a predominant degree of product gas since CO₂ and/or CO itself can remain dissolved and/or have been consumed and hence the concentration in the electrolyte is somewhat lower. The electrolysis in FIG. 12 proceeds through addition of power via a power source (not shown).

In order to be able to control the flow of the water and the catholyte, valves 30 may optionally have been introduced in the anolyte circuit 10 and catholyte circuit 20. In the figure, the valves 30 are shown upstream of the inlet into the electrolysis cell, but may also be provided, for example, downstream of the outlet from the electrolysis cell and/or at other points in the anolyte circuit or catholyte circuit. It is also possible, for example, for there to be a valve 30 in the anolyte circuit upstream of the inlet into the electrolysis cell, while the valve in the catholyte circuit is downstream of the electrolysis cell, or vice versa. It is also possible to use various electrolysis cells, for example those shown in FIGS. 8 to 11.

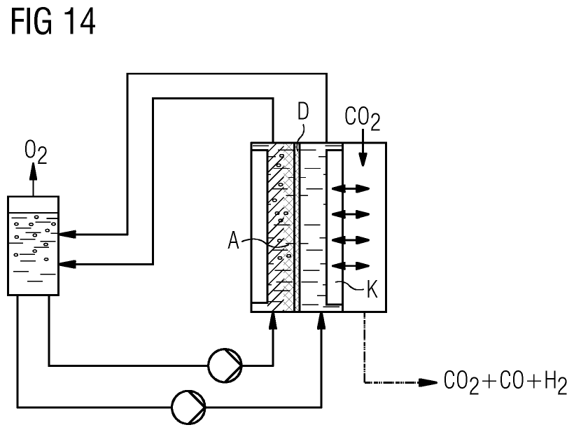

Further illustrative apparatuses with gas diffusion electrodes in flow-through and flow-by mode as cathodes are shown in FIGS. 13 and 14, wherein the carbon dioxide and/or CO is conducted here in countercurrent. Also provided in FIG. 14, rather than a membrane M, is a diaphragm D. Here too, apparatuses with mixed anolytes and catholytes are possible through use of corresponding electrolysis cells, as also described by way of example above.

The composition of a liquid or solution, for example an electrolyte solution, which is supplied to the electrolysis unit is not particularly restricted here, and may include all possible liquids or solvents, for example water, in which there may optionally additionally be electrolytes such as conductive salts, ionic liquids, substances for electrolytic conversion such as carbon dioxide and/or CO, which may be dissolved in water for example, additives for improving solubility and/or wetting characteristics, defoamers, etc. The catholyte may, for example, also include carbon dioxide and/or CO.

The liquids or solvents, optionally additional electrolytes such as conductive salts, ionic liquids, substances for electrolytic conversion, additives for improving the solubility and/or wetting characteristics, defoamers, etc., may be present at least in one electrode space or in both electrode spaces. It is also possible in each case for two or more of the substances or mixtures thereof mentioned to be included. These are not particularly restricted and may be used on the anode side and/or cathode side.

Rather than the construction shown in FIGS. 12 to 14 of an electrolysis system with an electrolysis cell comprising an anode space with anode A, a membrane M or a diaphragm D, and a cathode space with gas diffusion electrode K, it is also possible, for example, to employ the electrolysis cells shown in FIGS. 8 to 11 in an electrolysis system. The electrolysis cells or the electrolysis systems taught herein may be used, for example, in an electrolysis of carbon dioxide and/or CO.

Some embodiments include a method of electrolysis of CO₂ and/or CO, wherein a gas diffusion electrode as described herein is used, e.g. as cathode. In some embodiments, the process takes place at a temperature of 40° C. or more, for example 50° C. or more. In particular embodiments, an aqueous electrolyte is used.

The electrochemical reduction of CO₂ and/or CO can take place in an electrolysis cell that typically consists of an anode space and a cathode space. Anode space and cathode space are typically kept separate from one another by at least one ion-selective membrane and/or a diaphragm. FIGS. 8 to 11 show examples of possible cell arrangements of electrolysis cells for the inventive electrolysis of CO₂ and/or CO, which are also described in detail above. Any of these cell arrangements can be used to conduct the electrolysis method. In particular embodiments, the electrochemical reduction of CO₂ and/or CO is effected in flow-by mode.

Some embodiments include a method and an electrolysis system for electrochemical carbon dioxide and/or carbon monoxide utilization. Carbon dioxide (CO₂) and/or carbon monoxide (CO) can be introduced here, for example, into an electrolysis cell and reduced at a cathode with the aid of a gas diffusion electrode (GDE) on the cathode side. In order to assure sufficiently high conductivity in the cathode space, especially in the case of a CO₂ reduction, the aqueous electrolyte may contain a dissolved “conductive salt” which is not particularly restricted.

Some embodiments include a catalyst material comprising a metal M selected from Ag, Au, Cu and mixtures and/or alloys and/or salts thereof, wherein the catalyst material comprises dendritic and amorphous structures. The properties of the catalyst material correspond here to those that have already been mentioned in connection with the preparation process in the first aspect, since this can be obtained by the steps of:
providing a copper-, silver- and/or gold-containing starting material comprising at least one alkaline earth metal-copper, alkaline earth metal-silver and/or alkaline earth metal-gold phase, where the alkaline earth metal is selected from Mg, Ca, Sr, Ba and mixtures thereof;
introducing the starting material into a solution having a pH of less than 5 and reacting to give a catalyst material; and optionally
removing, washing and optionally drying the catalyst material.

The above embodiments, configurations and developments can, if viable, be combined with one another as desired. Further possible configurations, developments and implementations of the teachings herein also include non-explicitly specified combinations of features of the invention that have been described above or are described hereinafter with regard to the working examples. More particularly, the person skilled in the art will also add individual aspects as improvements of or additions to the respective basic form of the teachings of the present disclosure.

The scope of the disclosure is elucidated further in detail hereinafter with reference to various examples thereof. However, the scope is not limited to these examples.

### Reference Examples for Production of the Catalyst Material

For production of advantageous copper nanodendrites by a chemical route, a copper-magnesium alloy was treated in hydrochloric acid in the presence of dissolved copper ions. Illustrative element compositions were selected here across the entire range of the phase diagram (1 at. % Mg-99 at. % Mg). The starting alloy found was one that consists mainly of the intermetallic Laves phase Mg₂Cu. It was likewise possible to detect traces of the Laves phase Cu₂Mg according to the phase diagram in FIG. 1.

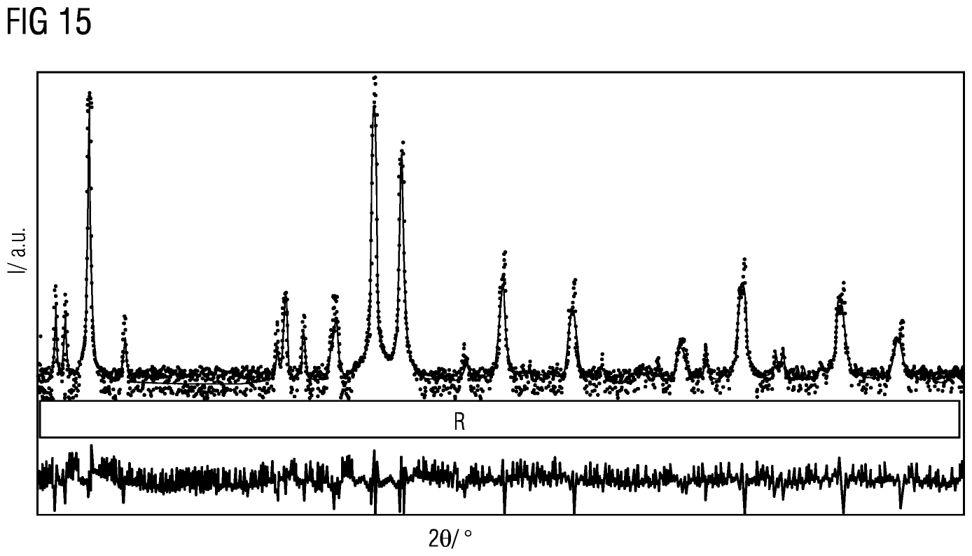

As well as the stable intermetallic phases Cu₂Mg and Mg₂Cu, a third metastable Cu₃Mg phase is known, which can be obtained by rapid quenching of the melt. By rapid solidification, it is likewise possible to obtain an amorphous alloy having a magnesium content of 14.5 at. %, in which the short-range order of the Cu atoms corresponds to that of the advantageous Mg₂Cu phase and which can likewise be used for the synthesis of the copper dendrites. FIG. 15 below shows a powder diffractogram, recorded with a Bruker Phaser D2 2^{nd} Gen powder diffractometer, of a Cu₂Mg-rich (90% by weight) alloy. FIG. 15 thus shows a quantitative phase analysis of a starting alloy for the process of the invention (Cu₂Mg-rich alloy).

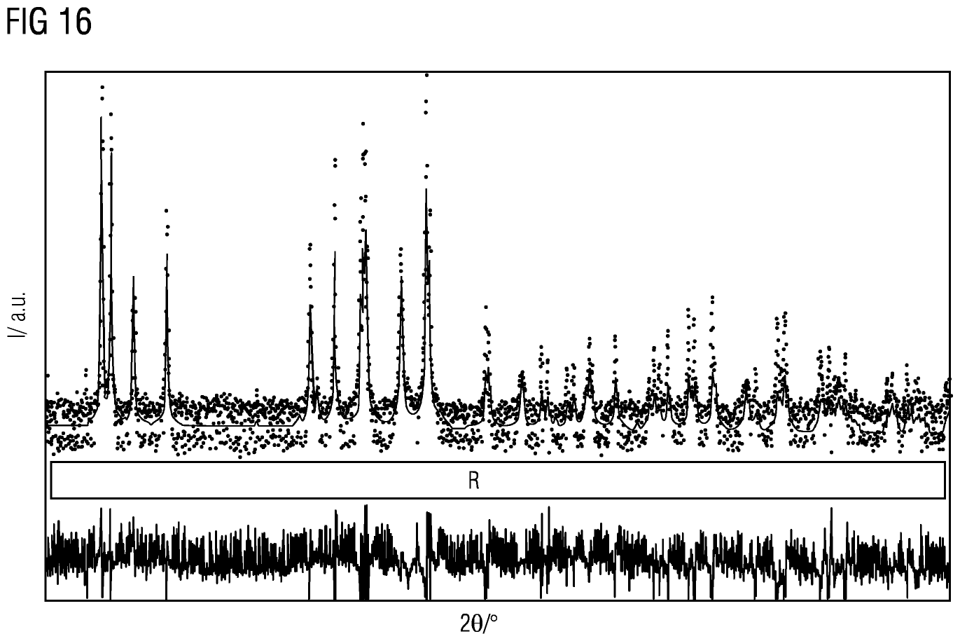

The starting material is suitable for production of an ethylene-selective catalyst, but it has been found that magnesium-rich alloys give catalysts with higher selectivity. The diffractogram in FIG. 16 shows an advantageous magnesium-rich alloy having an Mg₂Cu phase content of (86% by weight). FIG. 15 shows a quantitative phase analysis of a further starting alloy for the process of the invention (Mg₂Cu-rich alloy).

It has been found that the selected alloys are used for production of a gas diffusion electrode, e.g. with a grain size of <75 μm, although it is also possible to use coarser grain sizes of 75 μm-200 μm.

FIGS. 17 and 18 show TEM images (JEOL JEM-2200FS) of the Raney structure produced by straightforward leaching of Mg out of the Mg₂Cu-rich alloy with hydrochloric acid (5 g of alloy in a solution of 140 mL of 32% hydrochloric acid and 800 mL of dist. water).

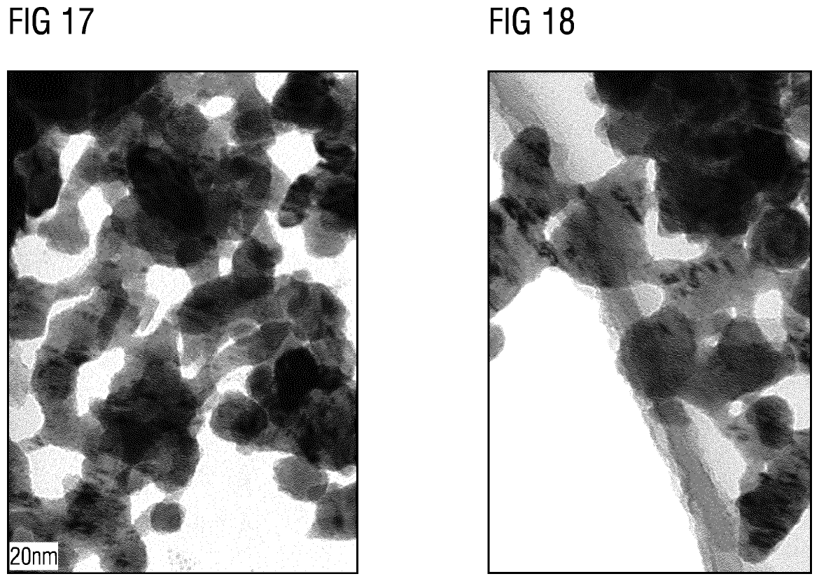

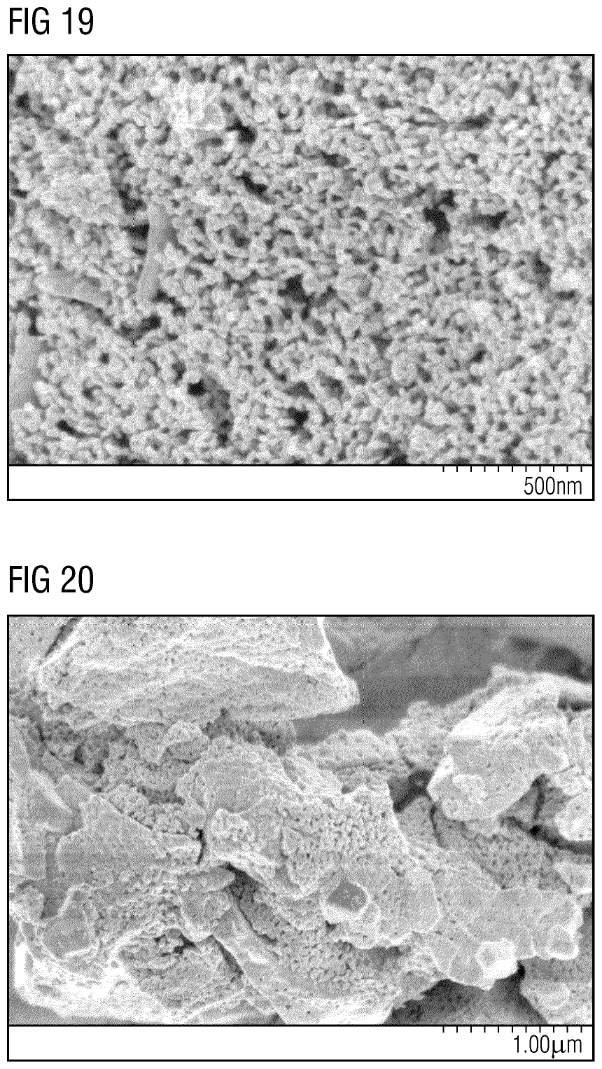

The structural difference in the use of Mg₂Cu and Cu₂Mg in the dissolving with hydrochloric acid (in the above ratio) is shown in FIGS. 19 and 20 (Jeol JSM 6610-La). FIG. 19 here shows production from Mg₂Cu, and FIG. 20 production from Cu₂Mg. For Mg₂Cu, it is possible to observe structuring with a multitude of dendrites.

The dissolution of the magnesium-rich alloy leads to a higher number of fine Cu structures that have elevated selectivity for the formation of ethylene. A high magnesium content ultimately leads to the complete breakdown of the microstructure. The copper-rich alloy Cu₂Mg, after the leaching of magnesium, has much coarser porous particles.

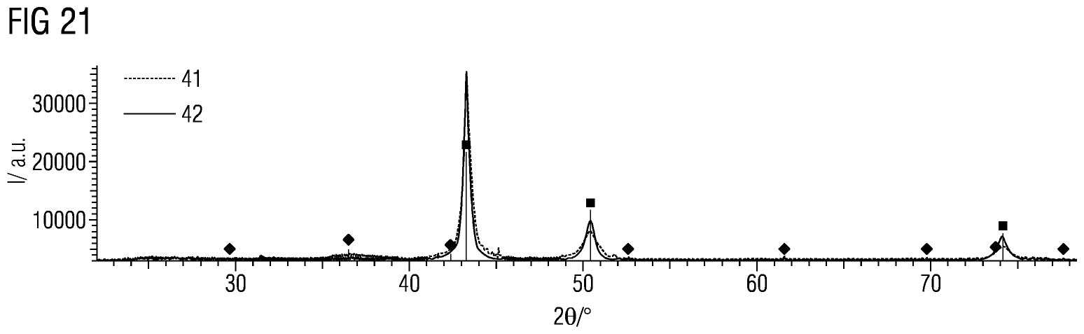

FIG. 21 shows the powder diffractograms of the two Raney structures produced, based on the two different starting alloys. The structure 41 from the Cu₂Mg-rich alloy and the structure 42 from the Mg₂Cu-rich alloy are compared, with the diamond showing Cu₂O cuprite and the square copper Cu.

The following peaks are found with the Miller indices according to table 2.

TABLE 2
Peak positions

| Peak position | |
|---|---|
| 2θ | HKL |
| 43.6 | (111) |
| 50.8 | (200) |
| 74.4 | (220) |

The material that was produced from the Mg₂Cu-rich alloy has a more marked presence of the Cu{111} texture. The material, on production to give a GDE, shows a high Faraday efficiency for the production of ethylene >25%. The significant peak broadening clearly indicates nanoparticles.

It has been shown that magnesium-rich alloys or intermetallic phases (Mg₂Cu) lead to defect-rich copper structures that enable a higher Faraday efficiency for ethylene.

As well as structural aspects, a thin layer of Cu₂O on the surface promotes the ethylene selectivity of the catalyst as determined. Production in the presence of atmospheric oxygen is sufficient for the purpose.

If the acid treatment takes place in the presence of dissolved copper ions, in addition to the production of a defect-rich Raney structure, the simultaneous growth of dendritic copper structures takes place; see also working example 2. In this process, hydrogen bubbles formed act as a template for the copper growth. This effect has already been detected in the electrochemical deposition of copper at high potentials. For this approach, the magnesium-rich phase Mg₂Cu has likewise been found to be advantageous. Mg₂Cu has much stronger hydrolysis characteristics than Cu₂Mg, since the bond strength of the Cu—Cu bond is much lower. Hydrolysis characteristics are thus observed even in pure water [Materials Letters 2008, 62, 19, p. 3331-3333].

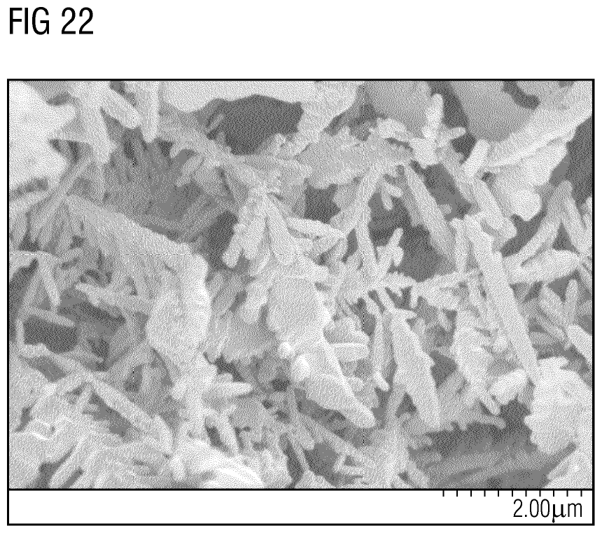

FIGS. 22-24 (SEM images) show the formation of 20 nm dendrites by simultaneous growth of copper in the course of dissolution of an Mg₂Cu-rich phase in the presence of dissolved Cu²⁺ ions.

The catalyst produced additionally has elevated selectivity for the formation of ethylene (<20% for the Cu₂Mg-rich alloy and >25% for the Mg₂Cu-rich alloy) after production of a gas diffusion electrode as disclosed below. As well as the elevated selectivity, a very low overvoltage was observed in the electrochemical reduction at J=150 mA/cm², and so the total cell voltage of U=2.8 V was achievable at electrode separation d=1 cm and with 1 M KHCO₃. Owing to its dendritic structure, the material is likewise characterized by very good electrical conductivity. It was likewise shown that the nanodendrites produced are stabilized by a thin magnesium oxide film. The processes described enable production of very pure catalysts that do not have any adverse contaminations by other transition metals.

For production of oxide-stabilized catalysts, the leaching can be performed in the presence of electrochemically stable support oxides (γ-Al₂O₃, MgO, TiO₂, Y₂O₃, ZrO₂), this being shown by way of example for TiO₂ in working examples 3 and 4 which follow. Preparation in the presence of a dissolved copper salt has been found to be less advantageous here, since the impregnation generates formation of supported Cu clusters that can have a Faraday efficiency of >45% for CO; see working example 3. By way of example, TiO₂ (Hombikat) was selected as oxidic support material having a specific surface area of 65 m²/g. The supported catalysts have an oxide content of 5-30% by weight, preferably 5-10% by weight, based on the catalyst. It has been observed that the synthesis can also give rise to a small proportion (<2% by weight) of an inverse Mg₂TiO₄ spinel. The basic prerequisite is the attainment of the copper percolation barrier, so that the material is electrically conductive. It is likewise not ruled out that a portion of the copper present in the catalyst may be present in the form of copper(I) oxide. The occurrence of copper(II) oxide should be avoided.

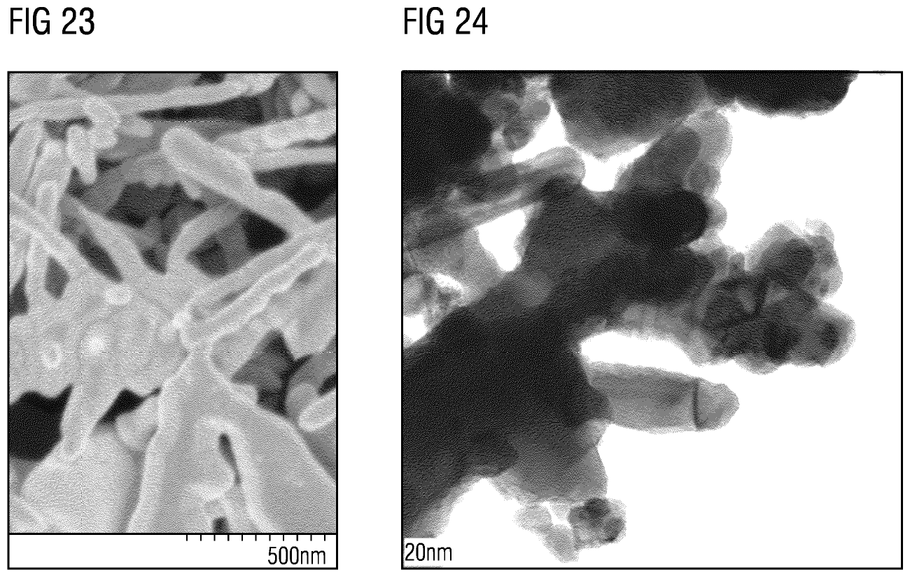

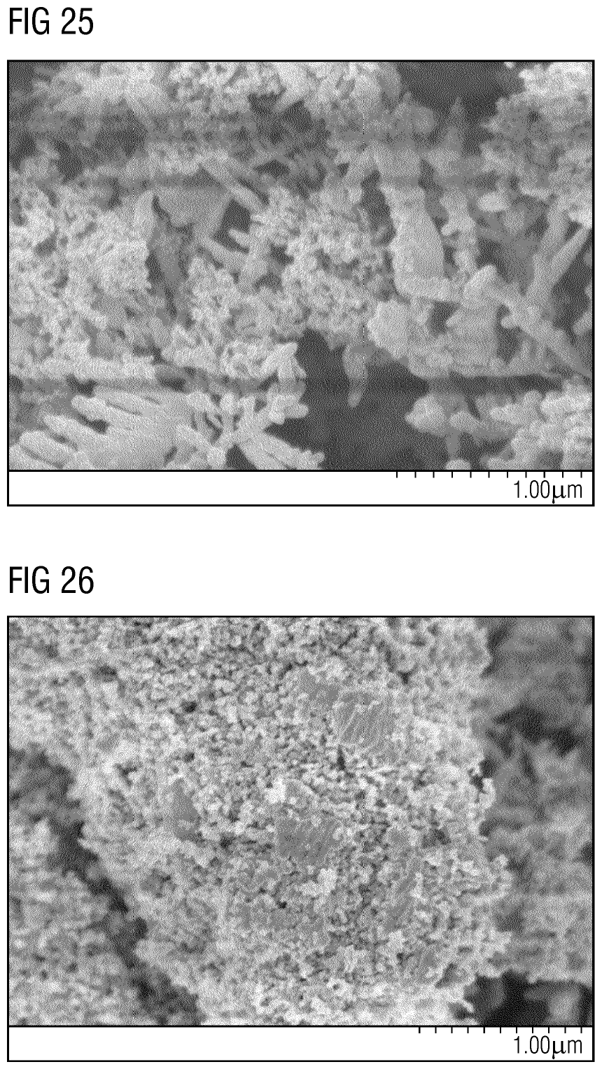

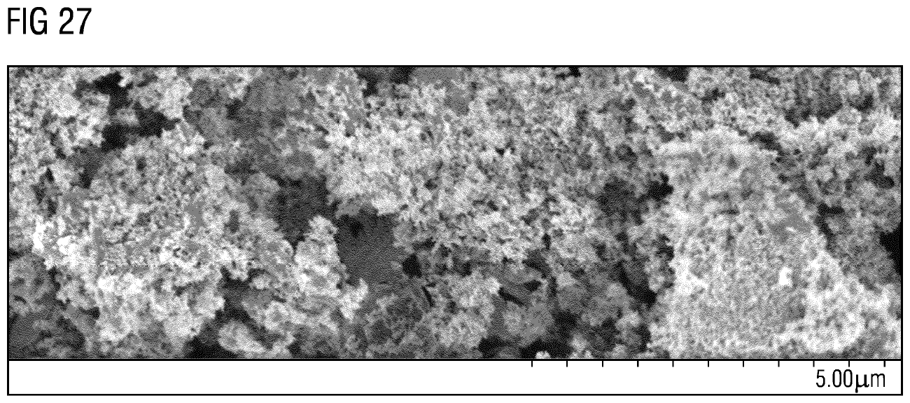

FIGS. 25-27 show SEM images of a TiO₂-stabilized dendritic Cu catalyst produced from the Mg₂Cu-rich starting alloy which is used in working example 3.

Owing to their morphology, the catalysts produced are suitable for production of a membrane-electrode array (MEA) based on an anion exchange membrane. With the aid of this concept, it was possible to achieve a Faraday efficiency >30% for ethylene.

### Working Example 1: Production of a Catalyst Based on a CuMg Alloy without Dendritic Deposition

5 g of alloy consisting of the dominant Mg₂Cu phase are rapidly transformed in a solution of 140 mL of 32% hydrochloric acid and 800 mL of dist. water. After the reaction has abated, the particles obtaining are washed by means of a suction filter (3× with 50 mL of dist. water, 3× with 50 mL of ethanol).

There is further addition of 500 mg (7.2% by weight) of PTFE powder (Dyneon TF 2021) with a mixing period of 3 min in an IKA A10 knife mill. The mixture is sieved onto a copper mesh (L×W=10 cm×4 cm) by means of a 0.5 mm-thick template and the excess material is removed with a spatula or squeegee, so as to give a powder layer of uniform thickness. The mesh with the sieved-on powder layer is rolled in a 2-roll calendar to a thickness of 500 μm. In this step, the rolls are preferably heated to a temperature of 60-80° C.

Electrochemical characterization was accomplished using an experimental setup corresponding essentially to that of the above-described electrolysis cell or of a corresponding system from FIG. 8 with flow cells for the electrolysis.

In the flow cell, the cathode used was the respective gas diffusion electrode (GDE) with an active area of 3.3 cm², the gas feed rate of carbon dioxide on the cathode side was 50 mL/min, and the electrolyte flow on both sides was 130 mL/min. The anode was iridium oxide on a titanium carrier having an active area of 10 cm². The catholyte was a 1 M KHCO₃ solution with KHCO₃ in a 1 M concentration, and the anolyte was 1 M KHCO₃, each in deionized water (18 MΩ), each in an amount of 100 mL, and the temperature was 25° C.

The catalyst obtaining gives a high Faraday efficiency for ethylene of >25% at a current density of 150 mA/cm². If the reaction is conducted in the presence of atmospheric oxygen, a thin Cu₂O layer can be detected at the surface of the nanoparticles.

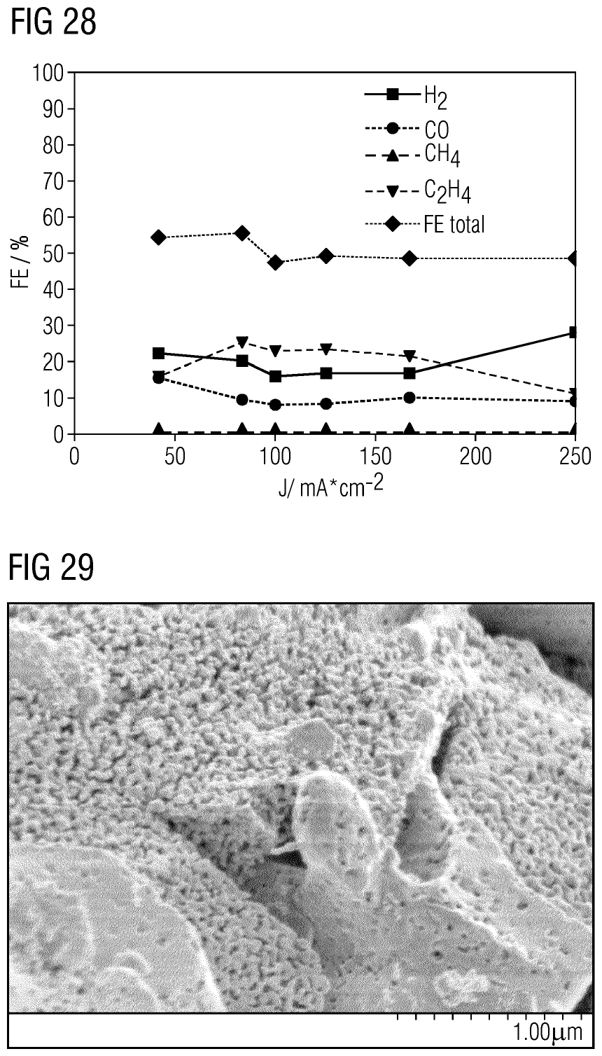

FIG. 28 shows the electrochemical characterization of the cell from working example 1. The figure shows the Faraday efficiency (FE) as a function of the current density J. The proportion of FE that is not shown can be assigned to liquid components that are not measured (e.g. ethanol+other C2, C3 species).

FIG. 29 additionally shows an SEM image of the surface of the GDE obtained. It was observed that the morphology of the dendrites was essentially unchanged over a period of two hours.

### Working Example 2: Production of a Catalyst Based on Cu—Mg with Dendritic Deposition

Copper dendrites formed from a CuMg alloy 400 mL of dist. water are mixed with 70 mL of 30% hydrochloric acid in a 1 L Erlenmeyer flask. Subsequently, 2.5 g of CuCl₂ are added. 2.5 g of an Mg₂Cu-rich alloy are added in portions while swirling the contents of the flask. After the reaction has abated (bubble formation), the material is filtered off as quickly as possible with a suction filter and washed 3× with 50 mL of water and 3× with 50 mL of ethanol. The particles are stored under inert gas. This is followed by the production of an electrode and electrochemical characterization as in working example 1.

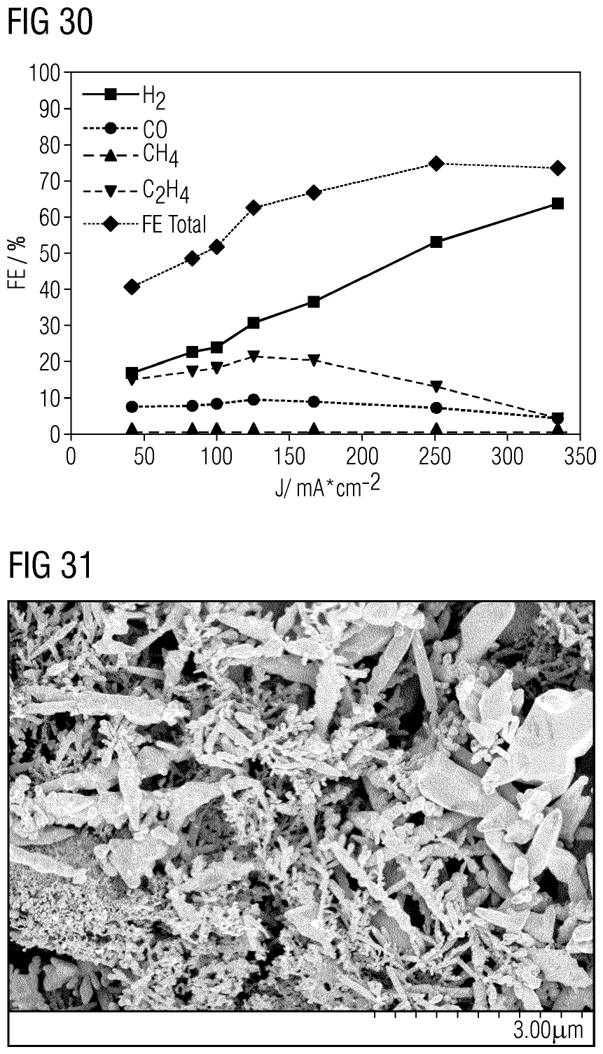

FIG. 30 shows the electrochemical characterization of the cell from working example 2. The figure again shows the Faraday efficiency (FE) as a function of current density y. FIG. 31 additionally shows an SEM image of the surface of the GDE obtained.

### Working Example 3: Production of a Catalyst Based on Cu—Mg with Dendritic Deposition and Oxide Supporting on TiO₂

800 mL of dist. water are mixed with 140 mL of 32% hydrochloric acid in a 2 L Erlenmeyer flask. This is followed by the addition of TiO₂ (Hombikat nanopowder according to batch, see table 3) with vigorous stirring. This is followed by the addition of 5 g of CuCl₂. After stirring for 10 minutes, 5 g of the CuMg alloy from working examples 1 and 2 are added in portions. After the reaction has abated (bubble formation), the material is filtered off as quickly as possible with a suction filter and washed 3× with 50 mL of dist. H₂O and 2× with 50 mL of ethanol and stored under inert gas. The starting weights for differently produced GDEs are shown in table 3.

TABLE 3

| Starting | | | | |
|---|---|---|---|---|
| weight of | Starting | Starting | | Proportion |
| CuMg (g) | weight of | weight of | Total mass | of TiO₂ |
| <75 μm | CuCl₂ (g) | TiO₂ (g) | of Cu (G) | (wt %) |
| 5 | 5 | 0.25 | 4.7 | 5 |
| 5 | 5 | 0.5 | 4.7 | 10 |
| 5 | 5 | 1.25 | 4.7 | 20 |
| 5 | 5 | 2 | 4.7 | 30 |

The catalyst powder obtained is washed with distilled water and subsequently with ethanol and dried under reduced pressure. The material is stored under an argon atmosphere. This is followed by the production of an electrode and electrochemical characterization as in working example 1.

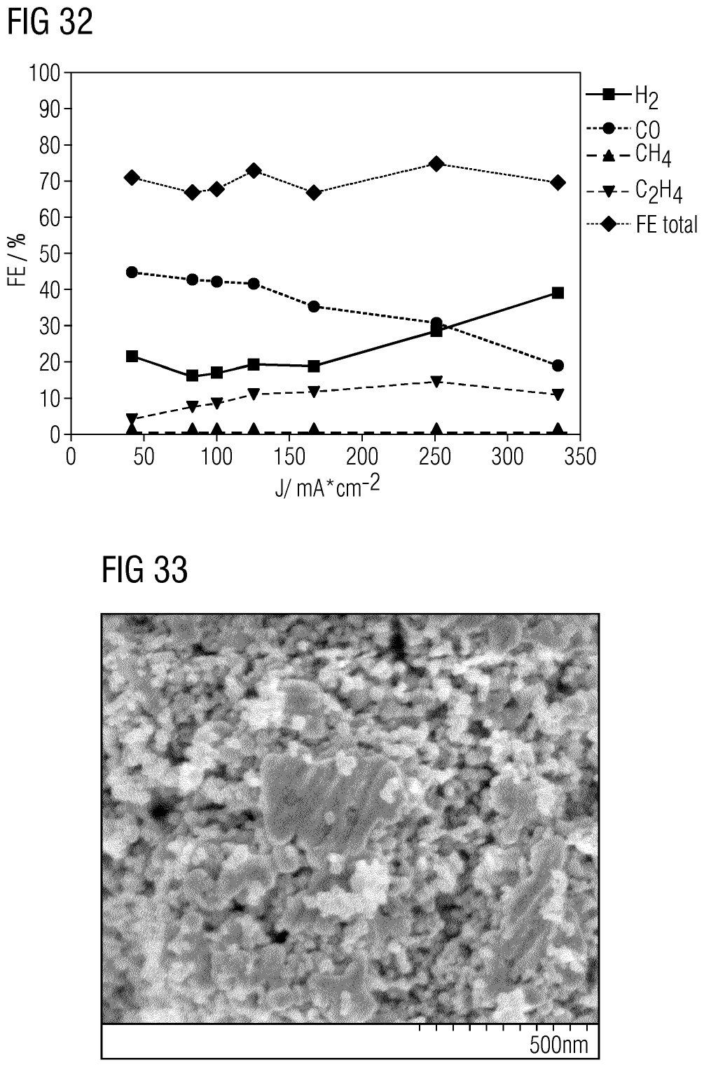

FIG. 32 shows the electrochemical characterization of the cell from working example 3 for supporting with 10% by weight of TiO₂. The figure again shows the Faraday efficiency (FE) as a function of current density J. FIG. 33 additionally shows an SEM image of the surface of the GDE obtained. An adverse effect is found as a result of the impregnation with copper salt.

By virtue of the supporting on oxide, it was possible to detect elevated stability of the catalyst at current densities >250 mA/cm².

### Working Example 4: Production of a Catalyst Based on Cu—Mg without Dendritic Deposition and Oxide Supporting on TiO₂

The production was as in working example 3, except that, rather than 5 g of CuCl₂ and 5 g of the CuMg alloy, 5 g of the Cu—Mg alloy from working example 1 were used. This is also apparent from table 4 below.

TABLE 4

| Starting | | |
|---|---|---|
| weight of | Starting | Proportion |
| CuMg (g) | weight of | of TiO₂ |
| <75 μm | CuCl₂ (g) | (wt %) |
| 5 | 0 | 5 |
| 5 | 0 | 10 |
| 5 | 0 | 20 |
| 5 | 0 | 30 |

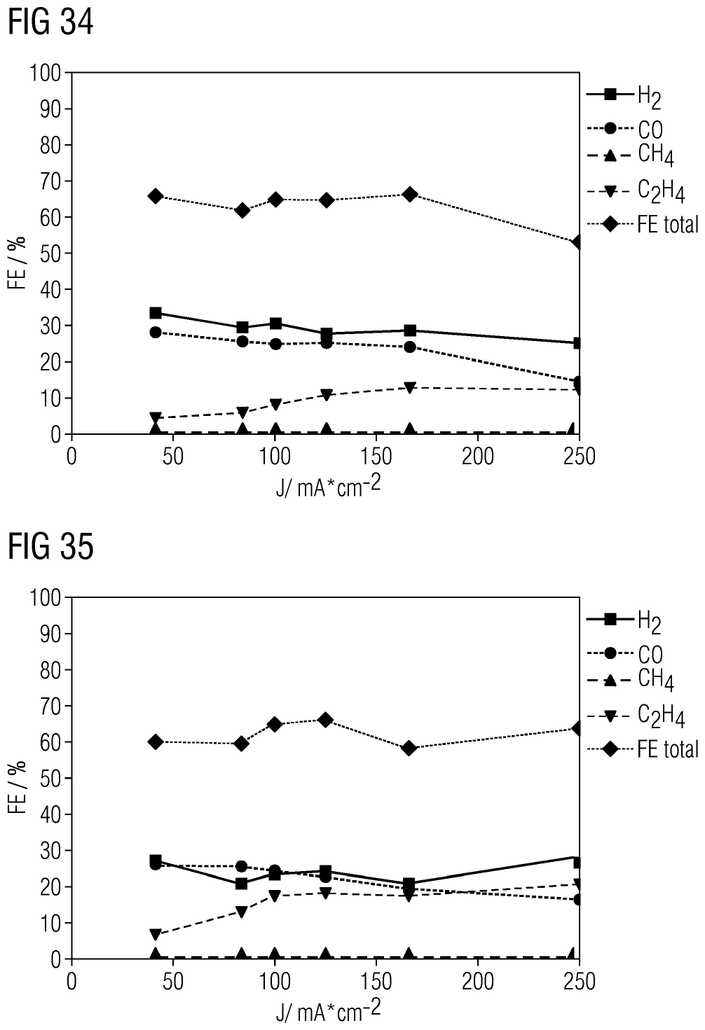

FIGS. 34 and 35 show the electrochemical characterization of the cells from working example 4 for supporting with 5% by weight of TiO₂ (FIG. 34) and 10% by weight of TiO₂ (FIG. 35). The figure again shows the Faraday efficiency (FE) as a function of the current density J.

The use of oxide supports such as TiO₂ leads to elevated formation of CO since smaller Cu clusters or nanoparticles that preferentially form CO and do not enable any further reaction are stabilized.

### Working Example 5: Production of Cu Dendrites from Cu—Al Alloy (Comparative Example)

The production was as in working example 1, except that, rather than the alloy consisting of the dominant Mg₂Cu phase, a Cu₄₀Al₆₀ alloy was used. The production of copper dendrites based on the Cu-aluminum alloy does not lead to the desired result. The copper catalyst, after the leaching-out of aluminum, has impurities of the acid-stable phases AlCu and Al₂Cu. These intermetallic phases have a low overvoltage for the formation of hydrogen. It was thus possible to obtain only a low Faraday efficiency for ethylene.

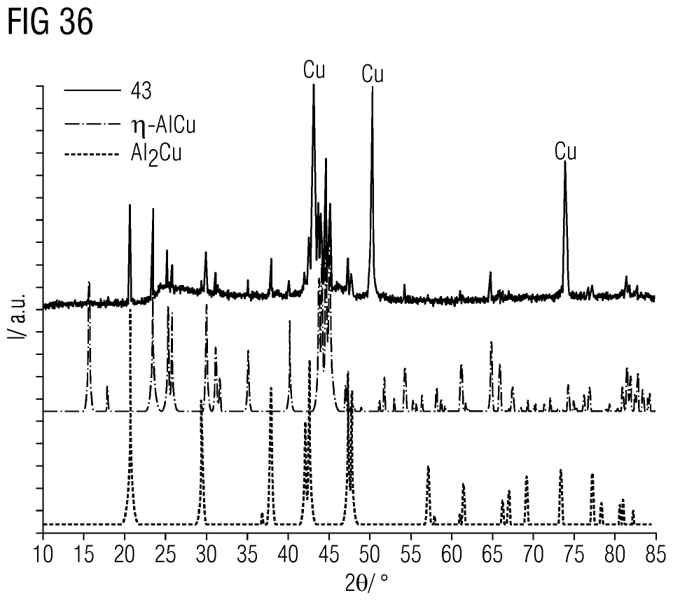

FIG. 36 here shows the identification of the sample prepared by means of Bruker Phaser D2 2^{nd} Gen powder diffractometer, especially the acid-stable phases Al₂Cu and AlCu.

### Working Example 6: Comparison of the Use of a Crystalline Alloy and an Amorphous Alloy

The starting material used in each case was a magnesium-containing starting alloy with the composition of 51.9 mol % of Mg₂Cu and 48.1 mol % of Mg, using firstly a crystalline alloy and secondly an amorphous alloy.

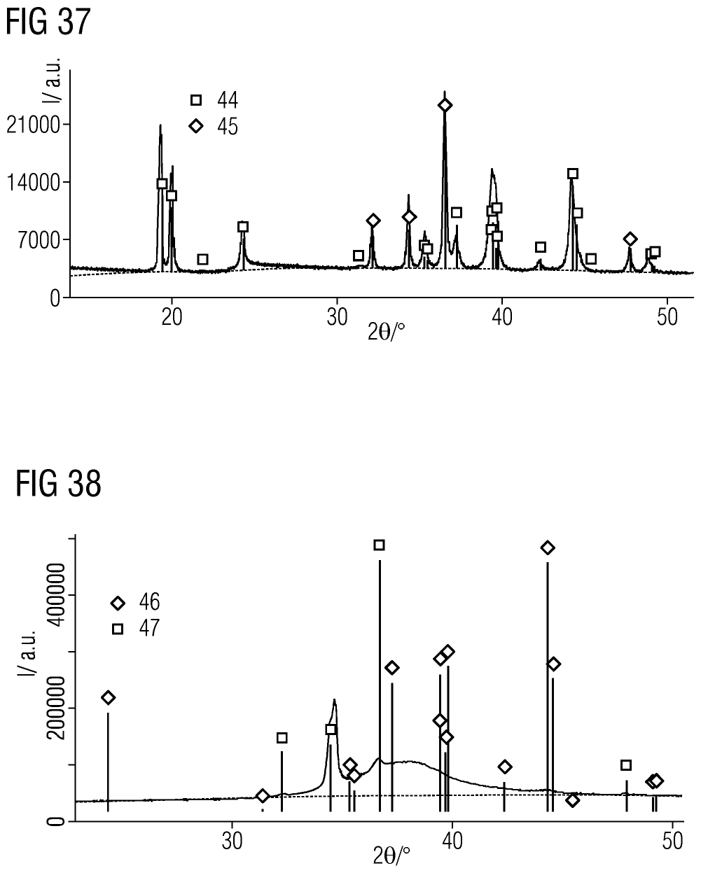

Both alloys have a similar Cu:Mg ratio, and both alloys have crystalline magnesium contents as apparent from the PXRD diagrams (Bruker Phaser D2 2^{nd} Gen powder diffractometer) in FIGS. 37 and 38, with FIG. 37 showing the crystalline alloy with an Mg₂Cu component 44 and Mg component 45, and FIG. 38 the amorphous alloy with an Mg₂Cu component 46 and Mg component 47. The magnesium present can contribute here to formation of an MgO oxide support. The amorphous alloy was used in order to produce particularly fine Cu structures. The amorphous alloy has crystalline components of the Mg₂Cu intermetallic phase.

The two starting materials were used, in accordance with the methods in working example 1, to produce a catalyst material.

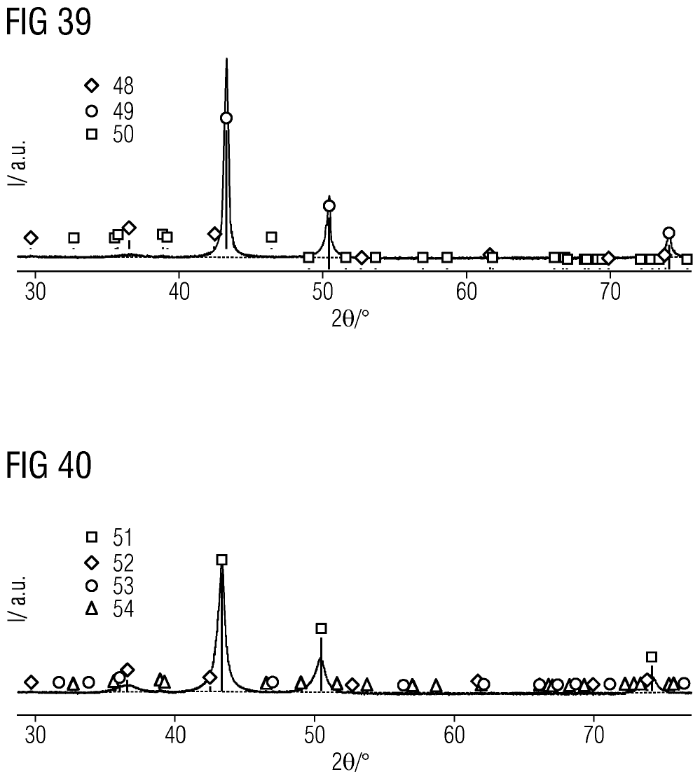

For this, PXRD spectra (Bruker Phaser D2 2^{nd} Gen powder diffractometer) are shown in FIGS. 39 and 40, with FIG. 39 in turn showing the crystalline alloy with a Cu₂O component 48 (cuprite), Cu 49 and CuO component 50 (tenorite), and FIG. 40 the amorphous alloy with a Cu component 51, Cu₂O component 52 (cuprite), Mg component 53 and CuO component 54 (tenorite).

The catalyst made from the crystalline alloy here has Cu crystallites >20 nm, whereas the catalyst made from the amorphous alloy has Cu crystallites <5 nm. Both catalysts include Cu₂O in the range of 1-3% by weight, and both catalysts include CuO in the range of <1% by weight. The catalyst made from the amorphous alloy is contaminated with magnesium residues <0.5% by weight. The catalyst morphology can thus be greatly affected by the choice of starting alloy and by its composition. Dendritic growth can be influenced by the proportion of Mg.

### Working Example 7: Production of a Catalyst Based on a CuMg Alloy without Dendritic Deposition

5 g of alloy consisting of the dominant Mg₂Cu phase (Hauner Metallische Werkstoffe) (51.9 mol % of Mg₂Cu and 48.1 mol % of Mg) are transformed rapidly in a solution of 140 mL of 32% hydrochloric acid and 800 mL of dist. water. After the reaction has abated, the particles obtaining are washed by means of a suction filter 3× with 50 mL of dist. water and 3× with 50 mL of ethanol. The further production of a GDE and of an electrolysis cell are as in working example 1.

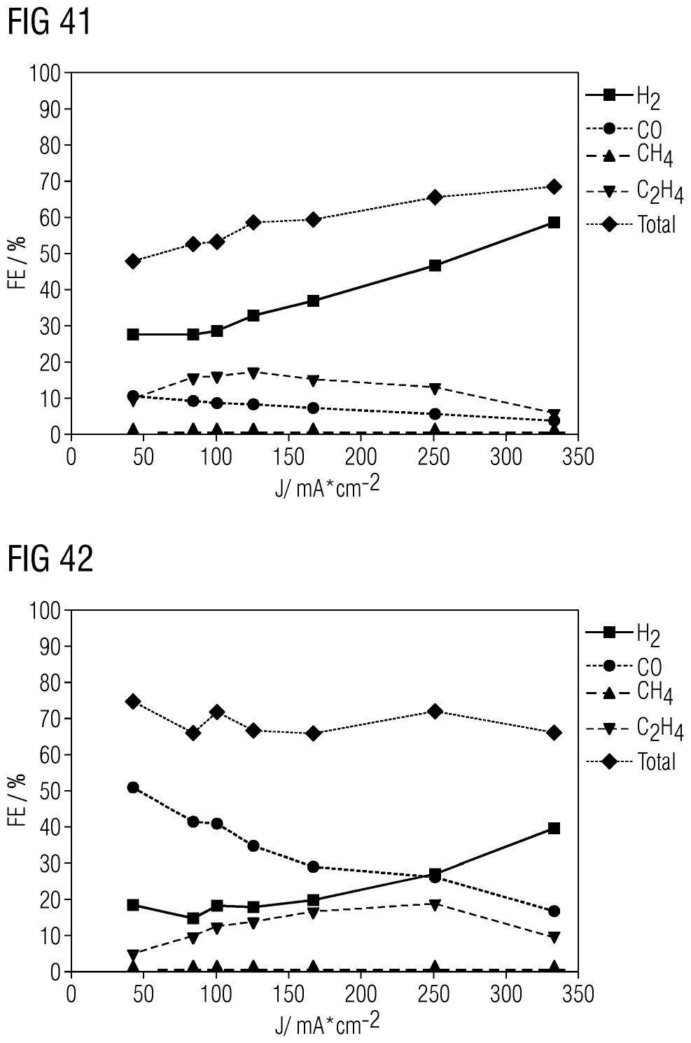

FIG. 41 shows the electrochemical characterization of the cell from working example 7. The figure again shows the Faraday efficiency (FT) as a function of current density J.

After the magnesium has been leached out of the crystalline starting alloy, the formation of nanoscale Cu crystallites >20 nm is observed. The electrical characterization shows that Cu crystallites in the middle nanometer range lead to lower CO formation. A magnesium-containing starting alloy is not advantageous for the catalyst production. Preference is therefore given to working with a pure Mg₂Cu starting phase.

### Working Example 8: Production of a Catalyst Based on a CuMg Alloy without Dendritic Deposition with an Amorphous Magnesium-Rich Alloy

5 g of alloy consisting of the dominant Mg₂Cu phase (51.9 mol % of Mg₂Cu and 48.1 mol % of Mg) are transformed rapidly in a solution of 140 mL of 32% hydrochloric acid and 800 mL of dist. water. After the reaction has abated, the particles obtaining are washed by means of a suction filter 3× with 50 mL of dist. water and 3× with 50 mL of ethanol. The further production of a GDE and of an electrolysis cell are as in working example 1.

FIG. 42 shows the electrochemical characterization of the cell from working example 8. The figure again shows the Faraday efficiency (FT) as a function of current density J.

By virtue of the random distribution of the Cu and magnesium atoms in the metal lattice of the starting alloy (amorphous state), after magnesium has been leached out, the formation of nanoscale Cu crystallites <5 nm is observed. Here too, the electrical characterization shows the result that Cu crystallites in the lower nanometer range lead to enhanced CO formation. A magnesium-containing starting alloy is thus again not advantageous for the catalyst production. Preference is therefore given to working with a pure Mg₂Cu starting phase.

The method disclosed here gives the option of producing dimensionally stable gas diffusion electrodes based on catalyst powder which can be used in a large-scale electrolyzer application within the scope of electrochemical CO₂ reduction and which enable improved long-term stability of electrolysis operation.

What is claimed is:

1. A method for producing a gas diffusion electrode comprising a metal M selected from Ag, Au, Cu and mixtures and/or alloys, the method comprising:
providing a copper-, silver- and/or gold-containing starting material comprising at least one alkaline earth metal-copper, alkaline earth metal-silver and/or alkaline earth metal-gold phase, where the alkaline earth metal is selected from the group consisting of: Mg, Ca, Sr, and Ba;
introducing the starting material into a solution having a pH of less than 5 and reacting to give a catalyst material;
removing and washing the catalyst material; and
processing the catalyst material to form a gas diffusion electrode.

2. The process as claimed in claim 1, wherein:
the starting material comprises the alkaline earth metal in an amount of 1 to 99 at. %; and
the starting material comprises at least one phase selected from the group consisting of:
Mg₂Cu, CaCu₅, SrCu₅, CuSr, BaCu, BaCu₁₃, Ca₂Ag₉, Ca₂Ag₇, CaAg₂, Ca₅Ag₃, MgAg, Mg₂₅Ag₈, SrAg₅, SrAg₂, SrAg, Sr₃Ag₂, BaAg₅, BaAg₂, BaAg, CaAu₅, CaAu₃, CaAu₂, CaAu, Ca₅Au₄, Ca₇Au₃, MgAu, Mg₂Au, Mg₃Au, SrAu₅, SrAu₂, SrAu, Sr₃Au₂, Sr₇Au₃, Sr₉Au, BaAu₅, BaAu₂, Ba₃Au₂, and BaAu; and
M comprises at least one metal selected from the group consisting of: Ag, Au, and Cu.

3. The process as claimed in claim 1, further comprising calcining the catalyst material after removing and washing the catalyst material; and
wherein the starting material, on introduction of the starting material into a solution having a pH of less than 5 and reacting to give a catalyst material, is not completely reacted.

4. The process as claimed in claim 1, further comprising, on introduction of the starting material, introducing at least one compound of Cu, Ag and/or Au, is also introduced.

5. The process as claimed in claim 1, wherein the processing of the catalyst material to give a gas diffusion electrode comprises the following steps:
producing a mixture comprising the catalyst material and a binder;
applying the mixture comprising the catalyst material and the binder to a substrate; and
dry or moistened rolling of the mixture onto the carrier to form a layer; or
applying the catalyst material to a substrate, preferably in the form of a sheetlike structure, and
dry or moistened rolling of the catalyst material onto the carrier to form a layer.

6. A gas diffusion electrode comprising:
at least one metal M selected from the group consisting of: Ag, Au, Cu;
dendrites containing alkaline earth metal-copper, alkaline earth metal-silver and/or alkaline earth metal-gold phases and/or at least one alkaline earth metal oxide.

7. The gas diffusion electrode as claimed in claim 6, wherein the gas diffusion electrode further comprises Cu, Ag and/or Au in the +I valency.

8. The gas diffusion electrode as claimed in claim 6, further comprising at least one carrier material comprising a metal oxide.

9. The gas diffusion electrode as claimed in any of claim 6, further comprising at least one binder and a substrate.

10. (canceled)

11. An electrolysis cell comprising:
a gas diffusion electrode as cathode comprising: at least one metal M selected from the group consisting of: Ag, Au, Cu; dendrites containing alkaline earth metal-copper, alkaline earth metal-silver and/or alkaline earth metal-gold phases and/or at least one alkaline earth metal oxide;
an anode; and
a membrane and/or a diaphragm between the cathode and anode.

12-13. (canceled)

14. The process as claimed in claim 1, further comprising, on introduction of the starting material, introducing at least one carrier material comprising a metal oxide, wherein the proportion of the carrier material in the catalyst material 2% to 40% by weight.
